(19) United States
(12) Patent Application Publication
(10) Pub. No.: US 2013/0107852 A1
(43) Pub. Date: May 2, 2013

(54) METHOD AND DEVICE FOR TRANSMITTING CONTROL INFORMATION IN WIRELESS COMMUNICATION SYSTEM

(71) Applicants: Seunghee Han, Anyang-si (KR); Hyunwoo Lee, Anyang-si (KR)

(72) Inventors: Seunghee Han, Anyang-si (KR); Hyunwoo Lee, Anyang-si (KR)

(73) Assignee: LG ELECTRONICS INC., Seoul (KR)

(21) Appl. No.: 13/809,879

(22) PCT Filed: Jul. 22, 2011
(86) PCT No.: PCT/KR11/05424

§ 371 Date: Jan. 11, 2013

Related U.S. Application Data
(60) Provisional application No. 61/366,939, filed on Jul. 23, 2010.
(60) Provisional application No. 61/368,267, filed on Jul. 28, 2010.

(51) Int. Cl. H04W 72/04

(52) U.S. Cl. CPC H04W 72/0413
USPC 370/329

(57) ABSTRACT

The present invention relates to a wireless communication system. In particular, the present invention relates to a method and a device for transmitting uplink control information in a situation where a plurality of cells are configured in a wireless communication system, the method comprising the steps of: selecting from a mapping table for an N number of HARQ-ARQ one PUCCH resource corresponding to an N number of specific HARQ-ACK from a plurality of PUCCH resources; and transmitting a bit value corresponding to an N number of specific HARQ-ACK in the mapping table for an N number of HARQ-ARQ using the selected PUCCH resource, wherein the mapping table for an N number of HARQ-ARQ is included in a mapping table for an M number of HARQ-ACK, and N is an integer less than M.

### TECHNICAL FIELD

The present invention relates to a wireless communication system, and more particularly to a method and apparatus for transmitting control information in a wireless communication system supporting carrier aggregation (CA).

### BACKGROUND ART

Wireless communication systems have been widely used to provide various kinds of communication services such as voice or data services. Generally, a wireless communication system is a multiple access system that can communicate with multiple users by sharing available system resources (bandwidth, transmission (Tx) power, and the like). A variety of multiple access systems can be used. For example, a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency-Division Multiple Access (SC-FDMA) system, and the like.

### DISCLOSURE

### Technical Problem

Accordingly, the present invention is directed to a method and apparatus for efficiently transmitting control information in a wireless communication system that substantially obviate one or more problems due to limitations and disadvantages of the related art. An object of the present invention is to provide a method and apparatus for efficiently transmitting control information in a wireless communication system. Another object of the present invention is to provide a channel format and signal processing for effectively transmitting control information, and an apparatus for the channel format and the signal processing. A further object of the present invention is to provide a method and apparatus for effectively allocating resources for transmitting control information.

It will be appreciated by persons skilled in the art that the objects that can be achieved through the present invention are not limited to what has been particularly described hereinabove and the above and other objects that the present invention can achieve will be more clearly understood from the following detailed description taken in conjunction with the accompanying drawings.

### Technical Solution

The object of the present invention can be achieved by providing a method for transmitting uplink control information (UCI) on the condition that a plurality of cells is configured in a wireless communication system, the method including: selecting one PUCCH (physical uplink control channel) resource corresponding to N specific HARQ ACKs (hybrid automatic repeat request-acknowledgements) from among a plurality of PUCCH resources in a mapping table for N HARQ-ARQs; and transmitting a bit value corresponding to the N HARQ-ACKs in the mapping table for the N HARQ-ARQs using the selected PUCCH resource, wherein the mapping table for the N HARQ-ARQs is contained in a mapping table for M HARQ-ACKs, where N≦M.

In another aspect of the present invention, a communication device for transmitting uplink control information (UCI) on the condition that a plurality of cells is configured in a wireless communication system includes: a radio frequency (RF) unit; and a processor, wherein the processor selects one PUCCH (physical uplink control channel) resource corresponding to N specific HARQ ACKs (hybrid automatic repeat request-acknowledgements) from among a plurality of PUCCH resources in a mapping table for N HARQ-ARQs, and transmits a bit value corresponding to the N HARQ-ACKs in the mapping table for the N HARQ-ARQs using the selected PUCCH resource, wherein the mapping table for the N HARQ-ARQs is contained in a mapping table for M HARQ-ACKs, where N≦M.

N may be an integer less than M.

M may be set to 4.

The plurality of cells may include a primary cell (PCell) and a secondary cell (SCell).

The PUCCH resource may include PUCCH format 1b resource.

### Advantageous Effects

Exemplary embodiments of the present invention have the following effects. Control information can be effectively transmitted in a wireless system. In addition, the embodiments of the present invention can provide a channel format and a signal processing method to effectively transmit control information. In addition, resources for transmitting control information can be effectively assigned.

It will be appreciated by persons skilled in the art that the effects that can be achieved through the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention, illustrate embodiments of the invention and together with the description serve to explain the principle of the invention.

FIG. 1 is a conceptual diagram illustrating physical channels used in a 3GPP LTE system acting as an exemplary mobile communication system and a general method for transmitting a signal using the physical channels.

FIG. 2 is a diagram illustrating a structure of a radio frame.

FIG. 3A is a conceptual diagram illustrating a method for processing an uplink signal.

FIG. 3B is a conceptual diagram illustrating a method for processing a downlink signal.

FIG. 4 is a conceptual diagram illustrating an SC-FDMA scheme and an OFDMA scheme applicable to embodiments of the present invention.

FIG. 5 is a conceptual diagram illustrating a signal mapping scheme in a frequency domain so as to satisfy single carrier characteristics.

FIG. 6 is a conceptual diagram illustrating the signal processing for mapping DFT process output samples to a single carrier in a clustered SC-FDMA.

FIGS. 7 and 8 show the signal processing in which DFT process output samples are mapped to multiple carriers in a clustered SC-FDMA.

FIG. 9 shows exemplary segmented SC-FDMA signal processing.

FIG. 10 shows an uplink subframe structure.

FIG. 11 is a conceptual diagram illustrating a signal processing procedure for transmitting a reference signal (RS) on uplink.

FIG. 12 shows demodulation reference signal (DMRS) structures for a physical uplink shared channel (PUSCH).

FIGS. 13 and 14 exemplarily show slot level structures of PUCCH formats 1a and 1b.

FIGS. 15 and 16 exemplarily show slot level structures of PUCCH formats 2/2a/2b.

FIG. 17 is a diagram showing ACK/NACK channelization of PUCCH formats 1a and 1b.

FIG. 18 is a diagram showing channelization of a structure in which PUCCH formats 1/1a/1b and PUCCH formats 2/2a/2b are mixed within the same PRB.

FIG. 19 is a diagram showing allocation of a physical resource allocation (PRB) used to transmit a PUCCH.

FIG. 20 is a conceptual diagram of management of a downlink component carrier (DLCC) in a base station (BS).

FIG. 21 is a conceptual diagram of management of an uplink component carrier (ULCC) in a user equipment (UE).

FIG. 22 is a conceptual diagram of the case where one MAC layer manages multiple carriers in a BS.

FIG. 23 is a conceptual diagram of the case where one MAC layer manages multiple carriers in a UE.

FIG. 24 is a conceptual diagram of the case where one MAC layer manages multiple carriers in a BS.

FIG. 25 is a conceptual diagram of the case where a plurality of MAC layers manages multiple carriers in a UE.

FIG. 26 is a conceptual diagram of the case where a plurality of MAC layers manages multiple carriers in a BS according to one embodiment of the present invention.

FIG. 27 is a conceptual diagram of the case where a plurality of MAC layers manages multiple carriers from the viewpoint of UE reception according to another embodiment of the present invention.

FIG. 28 is a diagram showing asymmetric carrier aggregation (CA) in which a plurality of downlink component carriers (DL CCs) and one uplink CC are linked.

FIGS. 29A to 29F are conceptual diagrams illustrating a DFT-S-OFDMA format structure and associated signal processing according to the embodiments of the present invention.

FIG. 30 shows ACK/NACK performance according to a channel selection scheme.

FIG. 31 exemplarily shows ACK/NACK codebook according to one embodiment of the present invention.

FIG. 32 is a block diagram illustrating a base station (BS) and a user equipment (UE) applicable to embodiments of the present invention.

### BEST MODE

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following embodiments of the present invention can be applied to a variety of wireless access technologies, for example, CDMA, FDMA, TDMA, OFDMA, SC-FDMA, MC-FDMA, and the like. CDMA can be implemented by wireless communication technologies, such as Universal Terrestrial Radio Access (UTRA) or CDMA2000. TDMA can be implemented by wireless communication technologies, for example, Global System for Mobile communications (GSM), General Packet Radio Service (GPRS), Enhanced Data rates for GSM Evolution (EDGE), etc. OFDMA can be implemented by wireless communication technologies, for example, IEEE 802.11 (Wi-Fi), IEEE 802.16 (WiMAX), IEEE 802.20, E-UTRA (Evolved UTRA), and the like. UTRA is a part of the Universal Mobile Telecommunications System (UMTS). 3rd Generation Partnership Project (3GPP) Long Term Evolution (LTE) is a part of Evolved UMTS (E-UMTS) that uses E-UTRA. The LTE-Advanced (LTE-A) is an evolved version of 3GPP LTE. Although the following embodiments of the present invention will hereinafter describe inventive technical characteristics on the basis of the 3GPP LTE/LTE-A system, it should be noted that the following embodiments will be disclosed only for illustrative purposes and the scope and spirit of the present invention are not limited thereto.

In a wireless communication system, the UE may receive information from the base station (BS) via a downlink, and may transmit information via an uplink. The information that is transmitted and received to and from the UE includes data and a variety of control information. A variety of physical channels are used according to categories of transmission (Tx) and reception (Rx) information of the UE.

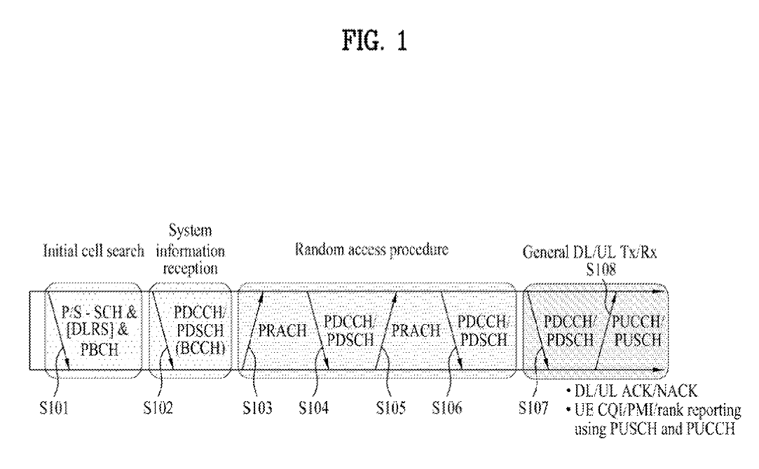

FIG. 1 is a conceptual diagram illustrating physical channels for use in a 3GPP system and a general method for transmitting a signal using the physical channels.

Referring to FIG. 1, when powered on or when entering a new cell, a UE performs initial cell search in step S101. The initial cell search involves synchronization with a BS. Specifically, the UE synchronizes with the BS and acquires a cell Identifier (ID) and other information by receiving a Primary Synchronization CHannel (P-SCH) and a Secondary Synchronization CHannel (S-SCH) from the BS. Then the UE may acquire information broadcast in the cell by receiving a Physical Broadcast CHannel (PBCH) from the BS. During the initial cell search, the UE may monitor a downlink channel status by receiving a downlink Reference Signal (DLRS).

After initial cell search, the UE may acquire more specific system information by receiving a Physical Downlink Control CHannel (PDCCH) and receiving a Physical Downlink Shared CHannel (PDSCH) based on information of the PDCCH in step S102.

Thereafter, if the UE initially accesses the BS, it may perform random access to the BS in steps S103 to S106. For random access, the UE may transmit a preamble to the BS on a Physical Random Access CHannel (PRACH) in step S103 and receive a response message for the random access on a PDCCH and a PDSCH corresponding to the PDCCH in step S104. In the case of contention-based random access, the UE may transmit an additional PRACH in step S105, and receive a PDCCH and a PDSCH corresponding to the PDCCH in step S106 in such a manner that the UE can perform a contention resolution procedure.

After the above random access procedure, the UE may receive a PDCCH/PDSCH (S107) and transmit a Physical Uplink Shared CHannel (PUSCH)/Physical Uplink Control CHannel (PUCCH) (S108) in a general uplink/downlink signal transmission procedure. Control information that the UE transmits to the BS is referred to as uplink control information (UCI). The UCI includes a Hybrid Automatic Repeat and reQuest ACKnowledgment/Negative-ACK (HARQ ACK/NACK) signal, a Scheduling Request (SR), Channel Quality Indictor (CQI), a Precoding Matrix Index (PMI), and a Rank Indicator (RI). The UCI is transmitted on a PUCCH, in general. However, the UCI can be transmitted on a PUSCH when control information and traffic data need to be transmitted simultaneously. Furthermore, the UCI can be aperiodically transmitted on a PUSCH at the request/instruction of a network.

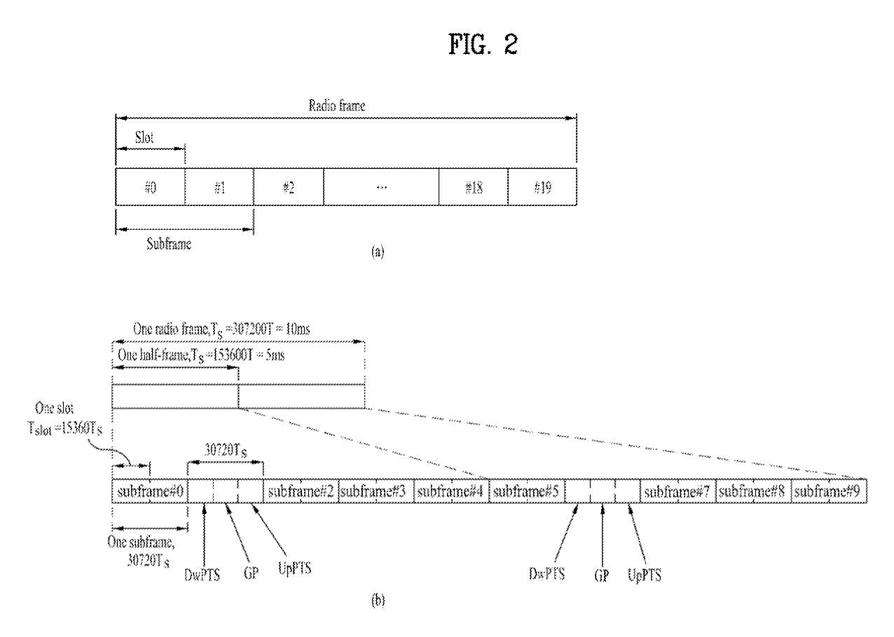

FIG. 2 illustrates a radio frame structure. In a cellular OFDM wireless packet communication system, UL/DL data packet transmission is performed based on subframe. One subframe is defined as a predetermined interval including a plurality of OFDM symbols. 3GPP LTE supports a type-1 radio frame applicable to Frequency Division Duplex (FDD) and type-2 radio frame applicable to Time Division Duplex (TDD).

FIG. 2(a) illustrates a type-1 radio frame structure. A DL radio frame includes 10 subframes each having 2 slots in the time domain. A time required to transmit one subframe is referred to as Transmission Time Interval (TTI). For example, one subframe is 1 ms long and one slot is 0.5 ms long. One slot includes a plurality of OFDM symbols in the time domain and a plurality of Resource Blocks (RBs) in the frequency domain. Since 3GPP LTE systems use OFDMA in downlink, an OFDM symbol represents one symbol interval. The OFDM symbol can be called an SC-FDMA symbol or symbol interval. An RB as a resource allocation unit may include a plurality of consecutive subcarriers in one slot.

The number of OFDM symbols included in one slot may depend on Cyclic Prefix (CP) configuration. CPs include an extended CP and a normal CP. When an OFDM symbol is configured with the normal CP, for example, the number of OFDM symbols included in one slot may be 7. When an OFDM symbol is configured with the extended CP, the length of one OFDM symbol increases, and thus the number of OFDM symbols included in one slot is smaller than that in case of the normal CP. In case of the extended CP, the number of OFDM symbols allocated to one slot may be 6. When channel state is unstable, such as a case in which a UE moves at a high speed, the extended CP can be used to reduce inter-symbol interference.

When the normal CP is used, one subframe includes 14 OFDM symbols since one slot has 7 OFDM symbols. The first three OFDM symbols at most in each subframe can be allocated to a PDCCH and the remaining OFDM symbols can be allocated to a PDSCH.

FIG. 2(b) illustrates a type-2 radio frame structure. The type-2 radio frame includes 2 half frames. Each half frame includes 5 subframes, a Downlink Pilot Time Slot (DwPTS), a Guard Period (GP), and an Uplink Pilot Time Slot (UpPTS), and one subframe consists of 2 slots. The DwPTS is used for initial cell search, synchronization or channel estimation. The UpPTS is used for channel estimation in a BS and UL transmission synchronization acquisition in a UE. The GP eliminates UL interference caused by multi-path delay of a DL signal between a UL and a DL.

The aforementioned structure of the radio frame is only exemplary, and various modifications can be made to the number of subframes contained in the radio frame or the number of slots contained in each subframe, or the number of OFDM symbols in each slot.

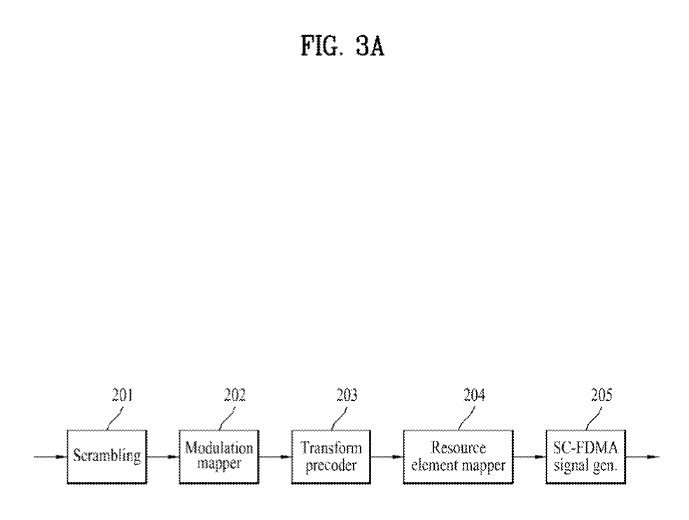

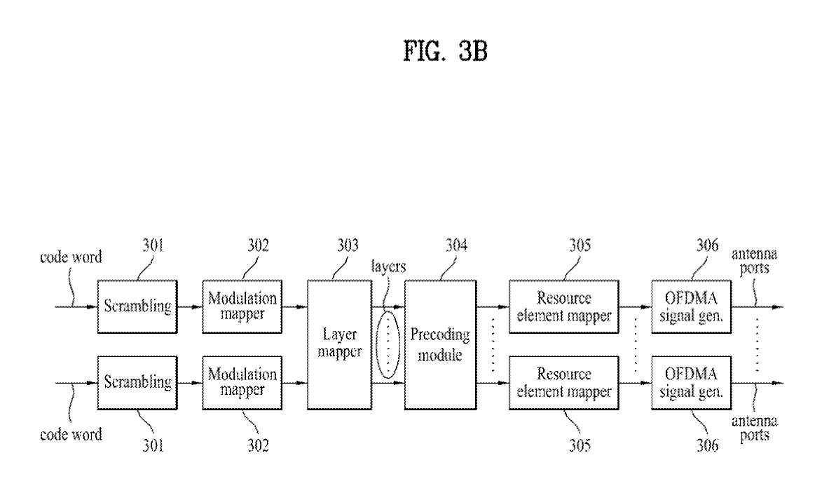

FIG. 3A is a conceptual diagram illustrating a signal processing method for transmitting an uplink signal by a user equipment (UE).

Referring to FIG. 3A, the scrambling module 201 may scramble a transmission signal in order to transmit the uplink signal. The scrambled signal is input to the modulation mapper 202, such that the modulation mapper 202 modulates the scrambled signal to complex symbols in Binary Phase Shift Keying (BPSK), Quadrature Phase Shift Keying (QPSK), or 16-ary Quadrature Amplitude Modulation (16QAM) according to the type of the transmission signal and/or a channel status. A transform precoder 203 processes the complex symbols and a resource element mapper 204 may map the processed complex symbols to time-frequency resource elements, for actual transmission. The mapped signal may be transmitted to the BS through an antenna after being processed in a Single Carrier-Frequency Division Multiple Access (SC-FDMA) signal generator 205.

FIG. 3B is a conceptual diagram illustrating a signal processing method for transmitting a downlink signal by a base station (BS).

Referring to FIG. 3B, the BS can transmit one or more codewords via a downlink in a 3GPP LTE system. Codewords may be processed as complex symbols by the scrambling module 301 and the modulation mapper 302 in the same manner as in the uplink operation shown in FIG. 3A. Thereafter, the complex symbols are mapped to a plurality of layers by the layer mapper 303, and each layer is multiplied by a predetermined precoding matrix and is then allocated to each transmission antenna by the precoder 304. The processed transmission signals of individual antennas are mapped to time-frequency resource elements (REs) to be used for data transmission by the RE mapper 305. Thereafter, the mapped result may be transmitted via each antenna after passing through the OFDMA signal generator 306.

In the case where a UE for use in a wireless communication system transmits an uplink signal, a Peak to Average Power Ratio (PAPR) may become more serious than in the case where the BS transmits a downlink signal. Thus, as described in FIGS. 3A and 3B, the SC-FDMA scheme is used for uplink signal transmission in a different way from the OFDMA scheme used for downlink signal transmission.

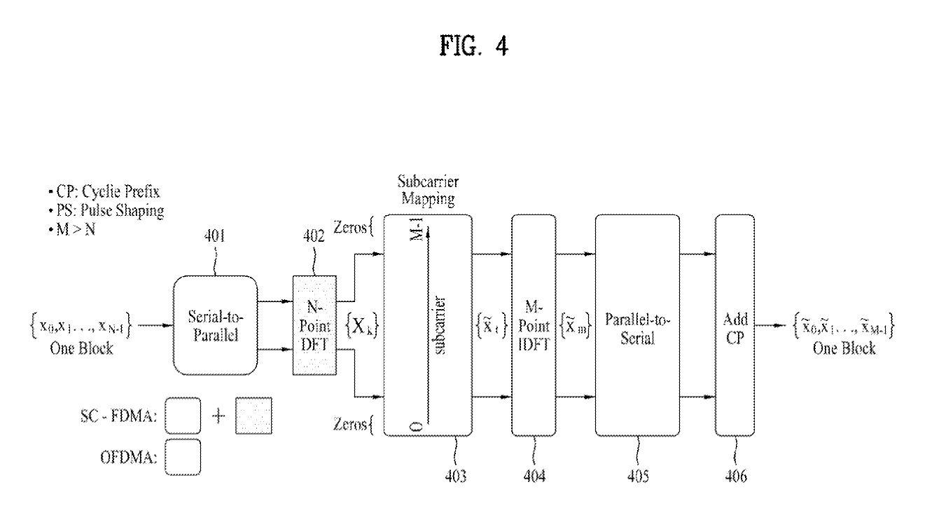

FIG. 4 is a conceptual diagram illustrating an SC-FDMA scheme and an OFDMA scheme applicable to embodiments of the present invention. In the 3GPP system, the OFDMA scheme is used in downlink and the SC-FDMA scheme is used in uplink.

Referring to FIG. 4, not only a UE for uplink signal transmission but also a BS for downlink signal transmission includes a Serial-to-Parallel converter 401, a subcarrier mapper 403, an M-point IDFT module 404 and a Cyclic Prefix (CP) addition module 406. However, a UE for transmitting a signal using the SC-FDMA scheme further includes an N-point DFT module 402, and compensates for a predetermined part of the IDFT processing influence of the M-point IDFT module 1504 so that a transmission signal can have single carrier characteristics (i.e., single-carrier properties).

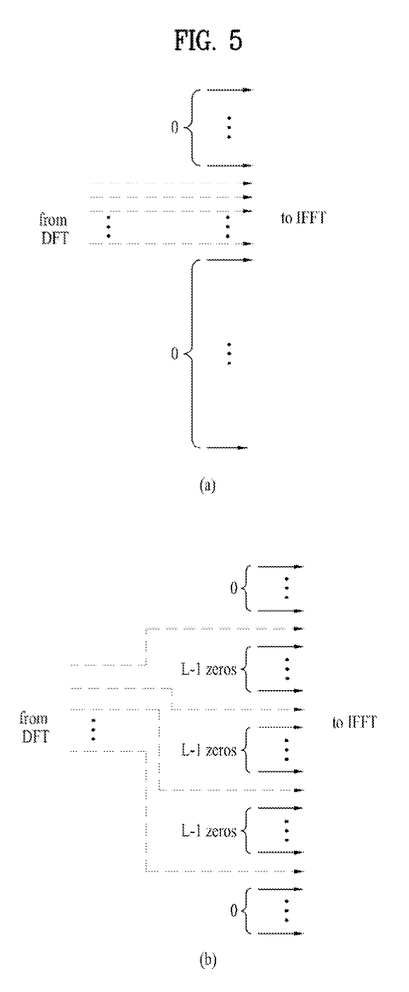

FIG. 5 illustrates a signal mapping scheme in the frequency domain for satisfying the single carrier properties. FIG. 5(a) shows a localized mapping scheme and FIG. 5(b) shows a distributed mapping scheme.

A clustered SC-FDMA scheme which is a modified form of the SC-FDMA scheme is described as follows. In the clustered SC-FDMA scheme, DFT process output samples are divided into sub-groups in a subcarrier mapping procedure and are non-contiguously mapped in the frequency domain (or subcarrier domain).

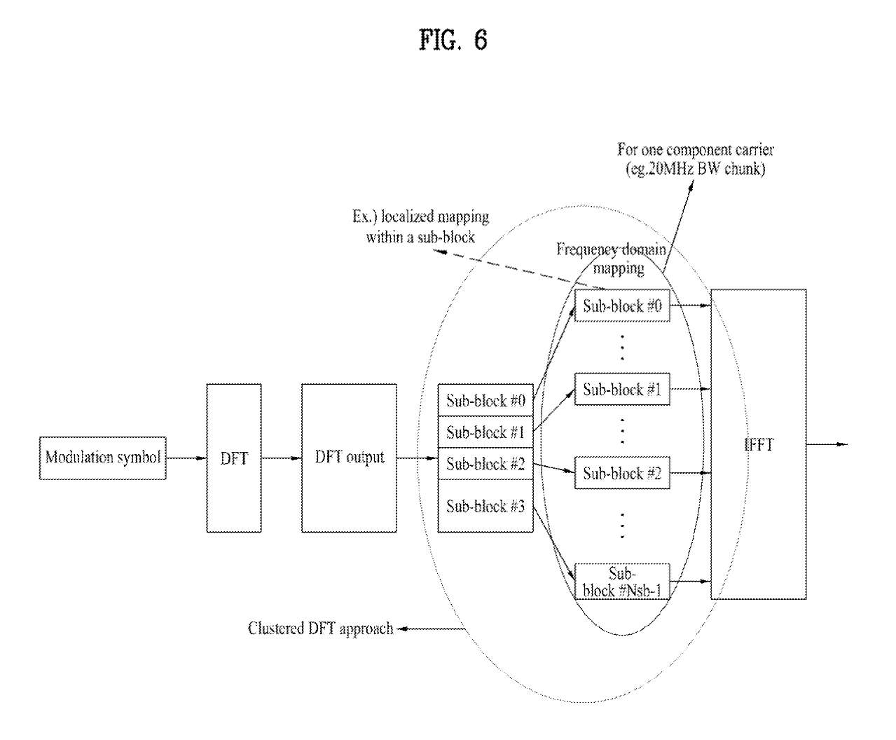

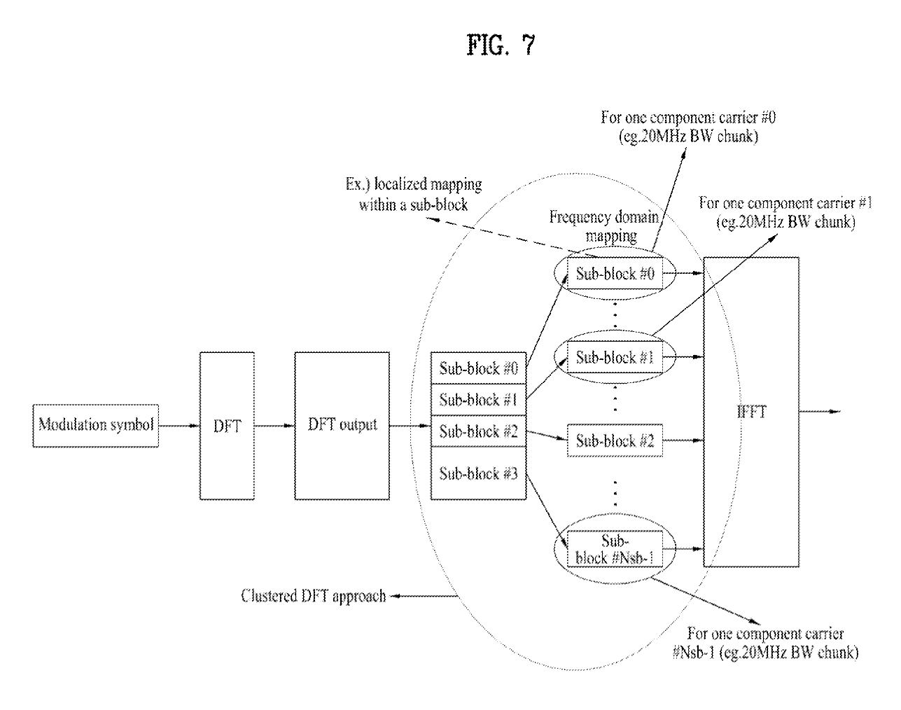

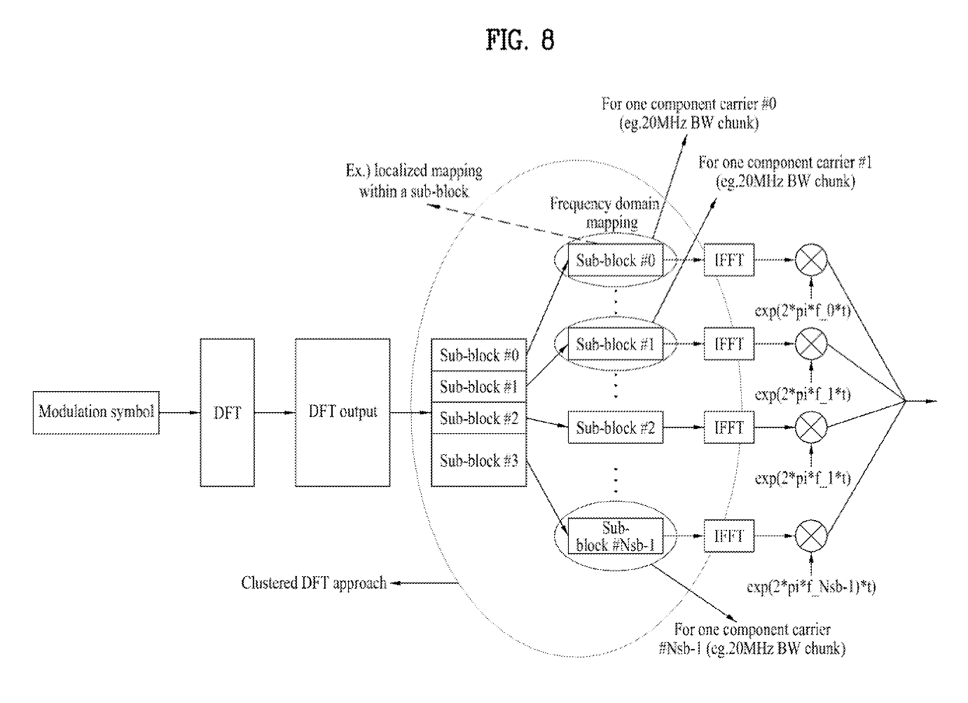

FIG. 6 shows signal processing in which DFT-process output samples are mapped to one carrier in the clustered SC-FDMA. FIGS. 7 and 8 show signal processing in which DFT process output samples are mapped to multicarriers in a clustered SC-FDMA. FIG. 6 shows the example of intra-carrier cluster SC-FDMA application. FIGS. 7 and 8 show examples of the inter-carrier clustered SC-FDMA application. FIG. 7 shows the example in which a signal is generated through a single IFFT block under the condition that component carriers are contiguously allocated to a frequency domain and the subcarrier spacing between contiguous component carriers is arranged. FIG. 8 shows another example in which a signal is generated through several IFFT blocks under the condition that component carriers are non-contiguously allocated to a frequency domain.

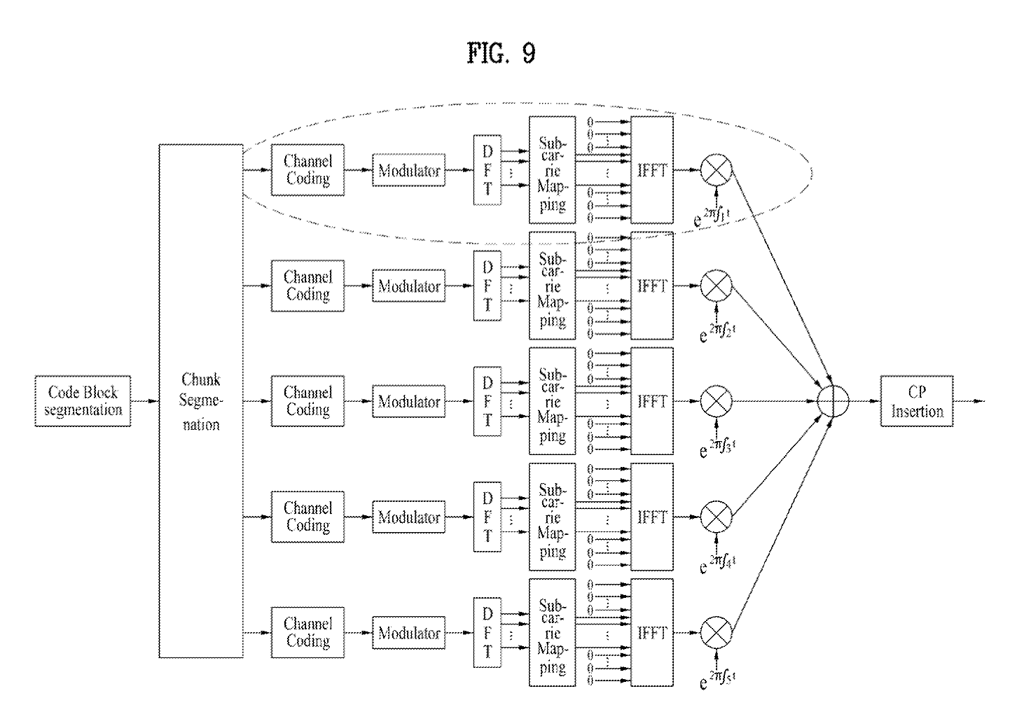

FIG. 9 shows exemplary segmented SC-FDMA signal processing.

The segmented SC-FDMA to which the same number of IFFTs as an arbitrary number of DFTs is applied may be considered to be an extended version of the conventional SC-FDMA DFT spread and the IFFT frequency subcarrier mapping structure because the relationship between DFT and IFFT is one-to-one basis. If necessary, the segmented SC-FDMA may also be represented by NxSC-FDMA or NxDFT-s-OFDMA. For convenience of description and better understanding of the present invention, the segmented SC-FDMA, NxSC-FDMA and NxDFT-s-OFDMA may be generically referred to as ‘segment SC-FDMA’. Referring to FIG. 9, in order to reduce single carrier characteristics, the segment SC-FDMA groups all the time domain modulation symbols into N groups, such that a DFT process is performed in units of a group.

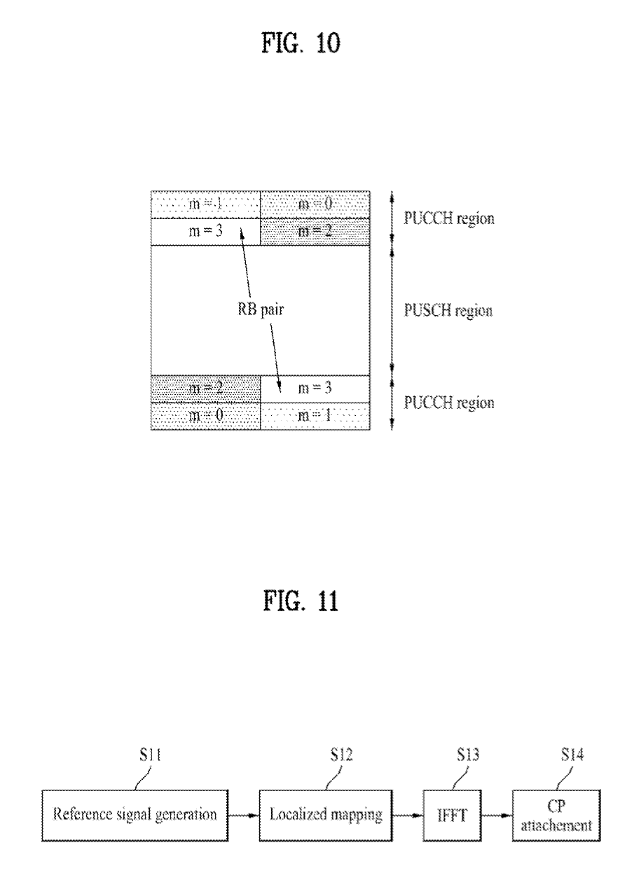

FIG. 10 shows an uplink subframe structure.

As shown in FIG. 10, the UL subframe includes a plurality of slots (e.g., two slots). Each slot may include a plurality of SC-FDMA symbols, the number of which varies according to the length of a CP. For example, in the case of a normal CP, a slot may include seven SC-FDMA symbols. A UL subframe is divided into a data region and a control region. The data region includes a PUSCH and is used to transmit a data signal such as voice. The control region includes a PUCCH and is used to transmit control information. The PUCCH includes a pair of RBs (e.g., m=0, 1, 2, 3) located at both ends of the data region on the frequency axis (specifically, a pair of RBs at frequency mirrored locations) and hops between slots. The UL control information (i.e., UCI) includes HARQ ACK/NACK, Channel Quality Information (CQI), Precoding Matrix Indicator (PMI), and Rank Indication (RI).

FIG. 11 illustrates a signal processing procedure for transmitting a Reference Signal (RS) in the uplink. As shown in FIG. 11, data is transformed into a frequency domain signal by a DFT precoder and the signal is then transmitted after being subjected to frequency mapping and IFFT. On the other hand, an RS does not pass through the DFT precoder. More specifically, an RS sequence is directly generated in the frequency domain (S11) and is then transmitted after being sequentially subjected to a localized-mapping process (S12), an IFFT process (S13), and a CP attachment process (S14).

The RS sequence r^{(α)}_{u,v}(n) is defined by a cyclic shift a of a base sequence and may be expressed by the following equation 1.

[Equation 1]

r^{(α)}_{u,v}(n)=e^{jαn} r̅_{u,v}(n), 0≦n<M^{RS}_{sc},

where M^{RS}_{sc}=mN^{RB}_{sc} denotes the length of the RS sequence, N^{RB}_{sc} denotes the size of a resource block represented in subcarriers, and m is 1≦m≦N^{max, UL}_{RB}. N^{max, UL}_{RB} denotes a maximum UL transmission band.

A base sequence r̅_{u,v}(n) is divided into several groups. u∈{0,1, . . . , 29} denotes group number, and v corresponds to a base sequence number in a corresponding group. Each group includes one base sequence v=0 having a length of M^{RS}_{sc}=mN^{RB}_{sc}(1≦m≦5) and two base sequences v=0,1 having a length of M^{RS}_{sc}=mN^{RB}_{sc}(6≦m≦N^{max, UL}_{RB}). The sequence group number u and the number v within a corresponding group may be changed with time. The base sequence r̅_{u,v}(0), . . . , r̅_{u,v}(M^{RS}_{sc}−1) is defined based on a sequence length M^{RS}_{sc}.

The base sequence having a length of 3N^{RB}_{sc} or more may be defined as follows.

With respect to M^{RS}_{sc}≧3N^{RB}_{sc}, the base sequence r̅_{u,v}(0), . . . , r̅_{u,v}(M^{RS}_{sc}−1)is given by the following equation 2.

[Equation 2]

r̅_{u,v}(n)=x_{q}(nmodN^{RS}_{ZC}), 0≦n<M^{RS}_{sc}−1,

where a q-th root Zadoff-Chu sequence may be defined by the following equation 3.

$${x}_{q} ( m ) = {e}^{- j \frac{π qm ( m + 1 )}{{N}_{ZC}^{RS}}} , 0 \leq m \leq {N}_{ZC}^{RS} - 1 , \qquad [ Equation 3 ]$$

where q satisfies the following equation 4.

[Equation 4]

q=└ q̅+½┘+v·(−1)^{└2q┘}

q̅=N^{RS}_{ZC}·(u+1)/31

where the length N^{RS}_{ZC} of the Zadoff-Chu sequence is given by the largest prime number, thus satisfying N^{RS}_{ZC}<M^{RS}_{sc}.

A base sequence having a length of less than 3N^{RB}_{sc} may be defined as follows. First, for M^{RS}_{sc}=N^{RB}_{sc} and M^{RS}_{sc}=2N^{RB}_{sc}, the base sequence is given as shown in Equation 5.

[Equation 5]

r̅_{u,v}(n)=e^{jφ(n)π/4}, 0≦n≦M^{RS}_{sc}−1,

where values for φ(n) for M^{RS}_{sc}=N^{RB}_{sc} and M^{RS}_{sc}=2N^{RB}_{sc} are given by the following Table 1, respectively.

TABLE 1

| u | φ(0), . . . , φ(11) | | | | | | | | | | | |
|---|---|---|---|---|---|---|---|---|---|---|---|---|
| 0 | −1 | 1 | 3 | −3 | 3 | 3 | 1 | 1 | 3 | 1 | −3 | 3 |
| 1 | 1 | 1 | 3 | 3 | 3 | −1 | 1 | −3 | −3 | 1 | −3 | 3 |
| 2 | 1 | 1 | −3 | −3 | −3 | −1 | −3 | −3 | 1 | −3 | 1 | −1 |
| 3 | −1 | 1 | 1 | 1 | 1 | −1 | −3 | −3 | 1 | −3 | 3 | −1 |
| 4 | −1 | 3 | 1 | −1 | 1 | −1 | −3 | −1 | 1 | −1 | 1 | 3 |
| 5 | 1 | −3 | 3 | −1 | −1 | 1 | 1 | −1 | −1 | 3 | −3 | 1 |
| 6 | −1 | 3 | −3 | −3 | −3 | 3 | 1 | −1 | 3 | 3 | −3 | 1 |
| 7 | −3 | −1 | −1 | −1 | 1 | −3 | 3 | −1 | 1 | −3 | 3 | 1 |
| 8 | 1 | −3 | 3 | 1 | −1 | −1 | −1 | 1 | 1 | 3 | −1 | 1 |
| 9 | 1 | −3 | −1 | 3 | 3 | −1 | −3 | 1 | 1 | 1 | 1 | 1 |
| 10 | −1 | 3 | −1 | 1 | 1 | −3 | −3 | −1 | −3 | −3 | 3 | −1 |
| 11 | 3 | 1 | −1 | −1 | 3 | 3 | −3 | 1 | 3 | 1 | 3 | 3 |
| 12 | 1 | −3 | 1 | 1 | −3 | 1 | 1 | 1 | −3 | −3 | −3 | 1 |
| 13 | 3 | 3 | −3 | 3 | −3 | 1 | 1 | 3 | −1 | −3 | 3 | 3 |
| 14 | −3 | 1 | −1 | −3 | −1 | 3 | 1 | 3 | 3 | 3 | −1 | 1 |
| 15 | 3 | −1 | 1 | −3 | −1 | −1 | 1 | 1 | 3 | 1 | −1 | −3 |
| 16 | 1 | 3 | 1 | −1 | 1 | 3 | 3 | 3 | −1 | −1 | 3 | −1 |
| 17 | −3 | 1 | 1 | 3 | −3 | 3 | −3 | −3 | 3 | 1 | 3 | −1 |
| 18 | −3 | 3 | 1 | 1 | −3 | 1 | −3 | −3 | −1 | −1 | 1 | −3 |
| 19 | −1 | 3 | 1 | 3 | 1 | −1 | −1 | 3 | −3 | −1 | −3 | −1 |
| 20 | −1 | −3 | 1 | 1 | 1 | 1 | 3 | 1 | −1 | 1 | −3 | −1 |
| 21 | −1 | 3 | −1 | 1 | −3 | −3 | −3 | −3 | −3 | 1 | −1 | −3 |
| 22 | 1 | 1 | −3 | −3 | −3 | −3 | −1 | 3 | −3 | 1 | −3 | 3 |
| 23 | 1 | 1 | −1 | −3 | −1 | −3 | 1 | −1 | 1 | 3 | −1 | 1 |
| 24 | 1 | 1 | 3 | 1 | 3 | 3 | −1 | 1 | −1 | −3 | −3 | 1 |
| 25 | 1 | −3 | 3 | 3 | 1 | 3 | 3 | 1 | −3 | −1 | −1 | 3 |
| 26 | 1 | 3 | −3 | −3 | 3 | −3 | 1 | −1 | −1 | 3 | −1 | −3 |
| 27 | −3 | −1 | −3 | −1 | −3 | 3 | 1 | −1 | 1 | 3 | −3 | −3 |
| 28 | −1 | 3 | −3 | 3 | −1 | 3 | 3 | −3 | 3 | 3 | −1 | −1 |
| 29 | 3 | −3 | −3 | −1 | −1 | −3 | −1 | 3 | −3 | 3 | 1 | −1 |

TABLE 2

| u | φ(0), . . . , φ(23) | | | | | | | | | | | | | | | | | | | | | | | |
|---|---|---|---|---|---|---|---|---|---|---|---|---|---|---|---|---|---|---|---|---|---|---|---|---|
| 0 | −1 | 3 | 1 | −3 | 3 | −1 | 1 | 3 | −3 | 3 | 1 | 3 | −3 | 3 | 1 | 1 | −1 | 1 | 3 | −3 | 3 | −3 | −1 | −3 |
| 1 | −3 | 3 | −3 | −3 | −3 | 1 | −3 | −3 | 3 | −1 | 1 | 1 | 1 | 3 | 1 | −1 | 3 | −3 | −3 | 1 | 3 | 1 | 1 | −3 |
| 2 | 3 | −1 | 3 | 3 | 1 | 1 | −3 | 3 | 3 | 3 | 3 | 1 | −1 | 3 | −1 | 1 | 1 | −1 | −3 | −1 | −1 | 1 | 3 | 3 |
| 3 | −1 | −3 | 1 | 1 | 3 | −3 | 1 | 1 | −3 | −1 | −1 | 1 | 3 | 1 | 3 | 1 | −1 | 3 | 1 | 1 | −3 | −1 | −3 | −1 |
| 4 | −1 | −1 | −1 | −3 | −3 | −1 | 1 | 1 | 3 | 3 | −1 | 3 | −1 | 1 | −1 | −3 | 1 | −1 | −3 | −3 | 1 | −3 | −1 | −1 |
| 5 | −3 | 1 | 1 | 3 | −1 | 1 | 3 | 1 | −3 | 1 | −3 | 1 | 1 | −1 | −1 | 3 | −1 | −3 | 3 | −3 | −3 | −3 | 1 | 1 |
| 6 | 1 | 1 | −1 | −1 | 3 | −3 | −3 | 3 | −3 | 1 | −1 | −1 | 1 | −1 | 1 | 1 | −1 | −3 | −1 | 1 | −1 | 3 | −1 | −3 |
| 7 | −3 | 3 | 3 | −1 | −1 | −3 | −1 | 3 | 1 | 3 | 1 | 3 | 1 | 1 | −1 | 3 | 1 | −1 | 1 | 3 | −3 | −1 | −1 | 1 |
| 8 | −3 | 1 | 3 | −3 | 1 | −1 | −3 | 3 | −3 | 3 | −1 | −1 | −1 | −1 | 1 | −3 | −3 | −3 | 1 | −3 | −3 | −3 | 1 | −3 |
| 9 | 1 | 1 | −3 | 3 | 3 | −1 | −3 | −1 | 3 | −3 | 3 | 3 | 3 | −1 | 1 | 1 | −3 | 1 | −1 | 1 | 1 | −3 | 1 | 1 |
| 10 | −1 | 1 | −3 | −3 | 3 | −1 | 3 | −1 | −1 | −3 | −3 | −3 | −1 | −3 | −3 | 1 | −1 | 1 | 3 | 3 | −1 | 1 | −1 | 3 |
| 11 | 1 | 3 | 3 | −3 | −3 | 1 | 3 | 1 | −1 | −3 | −3 | −3 | 3 | 3 | −3 | 3 | 3 | −1 | −3 | 3 | −1 | 1 | −3 | 1 |
| 12 | 1 | 3 | 3 | 1 | 1 | 1 | −1 | −1 | 1 | −3 | 3 | −1 | 1 | 1 | −3 | 3 | 3 | −1 | −3 | 3 | −3 | −1 | −3 | −1 |
| 13 | 3 | −1 | −1 | −1 | −1 | −3 | −1 | 3 | 3 | 1 | −1 | 1 | 3 | 3 | 3 | −1 | 1 | 1 | −3 | 1 | 3 | −1 | −3 | 3 |
| 14 | −3 | −3 | 3 | 1 | 3 | 1 | −3 | 3 | 1 | 3 | 1 | 1 | 3 | 3 | −1 | −1 | −3 | 1 | −3 | −1 | 3 | 1 | 1 | 3 |
| 15 | −1 | −1 | 1 | −3 | 1 | 3 | −3 | 1 | −1 | −3 | −1 | 3 | 1 | 3 | 1 | −1 | −3 | −3 | −1 | −1 | −3 | −3 | −3 | −1 |
| 16 | −1 | −3 | 3 | −1 | −1 | −1 | −1 | 1 | 1 | −3 | 3 | 1 | 3 | 3 | 1 | −1 | 1 | −3 | 1 | −3 | 1 | 1 | −3 | −1 |
| 17 | 1 | 3 | −1 | 3 | 3 | −1 | −3 | 1 | −1 | −3 | 3 | 3 | 3 | −1 | 1 | 1 | 3 | −1 | −3 | −1 | 3 | −1 | −1 | −1 |
| 18 | 1 | 1 | 1 | 1 | 1 | −1 | 3 | −1 | −3 | 1 | 1 | 3 | −3 | 1 | −3 | −1 | 1 | 1 | −3 | −3 | 3 | 1 | 1 | −3 |
| 19 | 1 | 3 | 3 | 1 | −1 | −3 | 3 | −1 | 3 | 3 | 3 | −3 | 1 | −1 | 1 | −1 | −3 | −1 | 1 | 3 | −1 | 3 | −3 | −3 |
| 20 | −1 | −3 | 3 | −3 | −3 | −3 | −1 | −1 | −3 | −1 | −3 | 3 | 1 | 3 | −3 | −1 | 3 | −1 | 1 | −1 | 3 | −3 | 1 | −1 |
| 21 | −3 | −3 | 1 | 1 | −1 | 1 | −1 | 1 | −1 | 3 | 1 | −3 | −1 | 1 | −1 | 1 | −1 | −1 | 3 | 3 | −3 | −1 | 1 | −3 |
| 22 | −3 | −1 | −3 | 3 | 1 | −1 | −3 | −1 | −3 | −3 | 3 | −3 | 3 | −3 | −1 | 1 | 3 | 1 | −3 | 1 | 3 | 3 | −1 | −3 |
| 23 | −1 | −1 | −1 | −1 | 3 | 3 | 3 | 1 | 3 | 3 | −3 | 1 | 3 | −1 | 3 | −1 | 3 | 3 | −3 | 3 | 1 | −1 | 3 | 3 |
| 24 | 1 | −1 | 3 | 3 | −1 | −3 | 3 | −3 | −1 | −1 | 3 | −1 | 3 | −1 | −1 | 1 | 1 | 1 | 1 | −1 | −1 | −3 | −1 | 3 |
| 25 | 1 | −1 | 1 | −1 | 3 | −1 | 3 | 1 | 1 | −1 | −1 | −3 | 1 | 1 | −3 | 1 | 3 | −3 | 1 | 1 | −3 | −3 | −1 | −1 |
| 26 | −3 | −1 | 1 | 3 | 1 | 1 | −3 | −1 | −1 | −3 | 3 | −3 | 3 | 1 | −3 | 3 | −3 | 1 | −1 | 1 | −3 | 1 | 1 | 1 |
| 27 | −1 | −3 | 3 | 3 | 1 | 1 | 3 | −1 | −3 | −1 | −1 | −1 | 3 | 1 | −3 | −3 | −1 | 3 | −3 | −1 | −3 | −1 | −3 | −1 |
| 28 | −1 | −3 | −1 | −1 | 1 | −3 | −1 | −1 | 1 | −1 | −3 | 1 | 1 | −3 | 1 | −3 | −3 | 3 | 1 | 1 | −1 | 3 | −1 | −1 |
| 29 | 1 | 1 | −1 | −1 | −3 | −1 | 3 | −1 | 3 | −1 | 1 | 3 | 1 | −1 | 3 | 1 | 3 | −3 | −3 | 1 | −1 | −1 | 1 | 3 |

RS hopping is described below.

The sequence group number u in a slot nₛ may be defined as shown in the following equation 6 by a group hopping pattern ƒ_{gh}(nₛ) and a sequence shift pattern ƒₛₛ.

[Equation 6]

u=(ƒ_{gh}(nₛ)+ƒₛₛ)mod30,

where mod denotes a modulo operation.

17 different hopping patterns and 30 different sequence shift patterns are present. Sequence group hopping may be enabled or disabled by a parameter for activating group hopping provided by a higher layer.

Although the PUCCH and the PUSCH have the same hopping pattern, the PUCCH and the PUSCH may have different sequence shift patterns.

The group hopping pattern ƒ_{gh}(nₛ) is the same for the PUSCH and the PUCCH and is given by the following equation 7.

$${f}_{gh} ( {n}_{s} ) = \{ \begin{matrix}0 & if group hopping is disabled \\ ( {\sum }_{i = o}^{7} c ( 8 {n}_{s} + i ) \cdot {2}^{i} ) mod 30 & if group hopping is enabled ,\end{matrix} \qquad [ Equation 7 ]$$

where c(i) denotes a pseudo-random sequence and a pseudo-random sequence generator may be initialized by

$${c}_{init} = ⌊ \frac{{N}_{ID}^{cell}}{30} ⌋$$

at the start of each radio frame.

The definition of the sequence shift pattern varies between the PUCCH and the PUSCH.

The sequence shift pattern ƒ^{PUCCH}ₛₛ of the PUCCH is ƒ^{PUCCH}ₛₛ=N^{cell}_{ID}mod30 and the sequence shift pattern ƒ^{PUCCH}ₛₛ of the PUSCH is ƒ^{PUCCH}ₛₛ=(ƒ^{PUCCH}ₛₛ+Δₛₛ)mod30. Δ_{SS} ∈{0, 1, . . . , 29} is configured by a higher layer.

The following is a description of sequence hopping.

Sequence hopping is applied only to an RS having a length of M^{RS}_{sc}≧6N^{RB}_{sc}.

For an RS having a length of M^{RS}_{sc}<6N^{RB}_{sc}, a base sequence number v within a base sequence group is v=0.

For an RS having a length of M^{RS}_{sc}≧6N^{RB}_{sc}, a base sequence number v within a base sequence group in a slot nₛ is given by the following equation 8.

$$[ Equation 8 ]$$

$$v = \{ \begin{matrix}c ( {n}_{s} ) & if group hopping is disabled and sequence hopping is enabled \\ 0 & otherwise ,\end{matrix}$$

where c(i) denotes a pseudo-random sequence and a parameter for enabling sequence hopping provided by a higher layer determines whether or not sequence hopping is possible. The pseudo-random sequence generator may be initialized as

$${c}_{init} = ⌊ \frac{{N}_{ID}^{cell}}{30} ⌋ \cdot {2}^{5} + {f}_{ss}^{PUSCH}$$

at the start of a radio frame.

An RS for a PUSCH is determined in the following manner.

The RS sequence r^{PUSCH}(.) for the PUCCH is defined as r_{PUSCH}(m·M^{RS}_{sc}+n)=r^{(a)}_{u,v}(n). Here, m and n satisfy ^{m=0,1}_{n=0, . . . , M}^{RS}_{sc-1} and satisfy M^{RS}_{sc}=M^{PUSCH}_{sc}.

A cyclic shift in one slot is given by α=2 n_{cs}/12 together with n_{cs}=(n⁽¹⁾_{DMRS}+n⁽²⁾_{DMRS}+n_{PRS}(nₛ)mod12.

Here, n⁽¹⁾_{DMRS} is a broadcast value, n⁽²⁾_{DMRS} is given by UL scheduling allocation, and n_{PRS}(nₛ) is a cell-specific cyclic shift value. n_{PRS}(nₛ) varies according to a slot number nₛ, and is given by n_{PRS}(nₛ)=Σ⁷ᵢ₌₀c(8·nₛ+i)·2ⁱ.

c(i) is a pseudo-random sequence and c(i) is also a cell-specific value. The pseudo-random sequence generator may be initialized as

$${c}_{init} = ⌊ \frac{{N}_{ID}^{cell}}{30} ⌋ \cdot {2}^{5} + {f}_{ss}^{PUSCH}$$

at the start of a radio frame.

Table 3 shows a cyclic shift field and n⁽²⁾_{DMRS} at a downlink control information (DCI) format 0.

TABLE 3

| Cyclic shift field at DCI format 0 | n_{DMRS}⁽²⁾ |
|---|---|
| 000 | 0 |
| 001 | 2 |
| 010 | 3 |
| 011 | 4 |
| 100 | 6 |
| 101 | 8 |
| 110 | 9 |
| 111 | 10 |

A physical mapping method for a UL RS at a PUSCH is as follows.

A sequence is multiplied by an amplitude scaling factor β^{PUSCH} and is mapped to the same physical resource block (PRB) set used for the corresponding PUSCH within the sequence that starts at r^{PUSCH}(0). When the sequence is mapped to a resource element (k,l) (l=3 for a normal CP and l=2 for an extended CP) within a subframe, the order of k is first increased and the slot number is then increased.

In summary, a ZC sequence is used along with cyclic extension if the length is greater than or equal to 3N^{RB}_{sc} and a computer-generated sequence is used if the length is less than 3N^{RB}_{sc}. The cyclic shift is determined according to a cell-specific cyclic shift, a UE-specific cyclic shift, a hopping pattern, and the like.

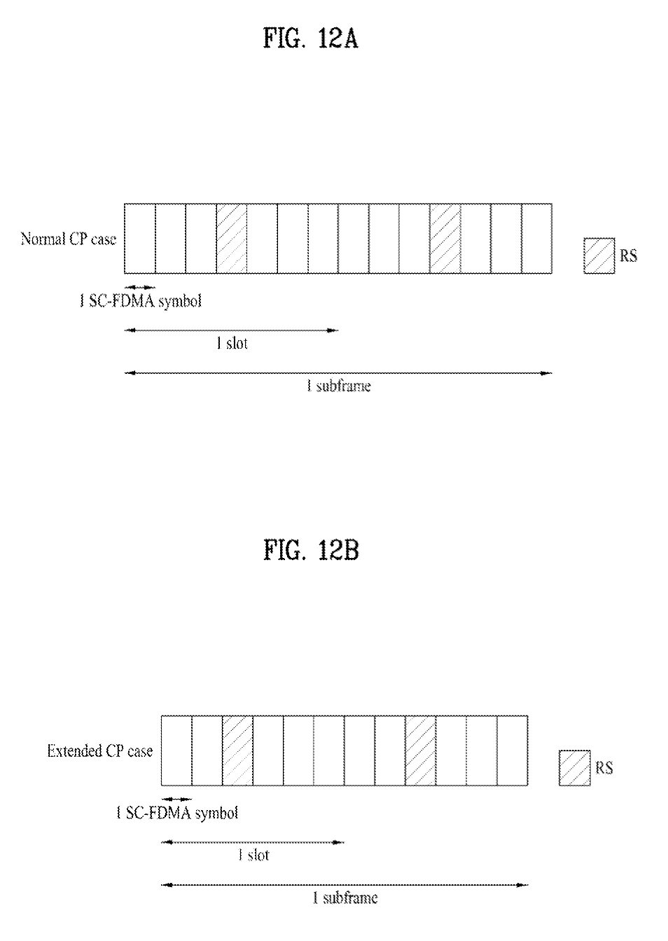

FIG. 12A illustrates the structure of a demodulation reference signal (DMRS) for a PUSCH in the case of normal CP and FIG. 12B illustrates the structure of a DMRS for a PUSCH in the case of extended CP. In the structure of FIG. 12A, a DMRS is transmitted through fourth and eleventh SC-FDMA symbols and, in the structure of FIG. 12B, a DMRS is transmitted through third and ninth SC-FDMA symbols.

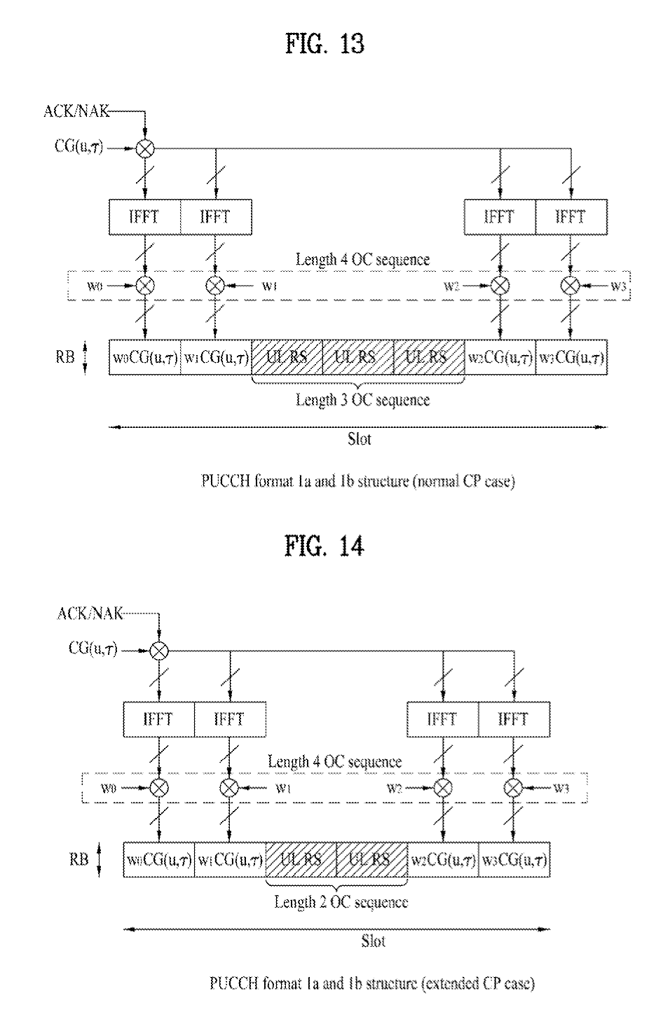

FIGS. 13 to 16 illustrate a slot level structure of a PUCCH format. The PUCCH includes the following formats in order to transmit control information.

(1) Format 1: Used for on-off keying (OOK) modulation and scheduling request (SR)

(2) Format 1a and Format 1b: Used for ACK/NACK transmission
1) Format 1a: BPSK ACK/NACK for one codeword
2) Format 1b: QPSK ACK/NACK for two codewords

(3) Format 2: Used for QPSK modulation and CQI transmission

(4) Format 2a and Format 2b: Used for CQI and ACK/NACK simultaneous transmission.

Table 4 shows a modulation scheme and the number of bits per subframe according to PUCCH format. Table 5 shows the number of RSs per slot according to PUCCH format. Table 6 shows SC-FDMA symbol locations of an RS according to PUCCH format. In Table 4, the PUCCH formats 2a and 2b correspond to the case of normal CP.

TABLE 4

| PUCCH | | Number of bits per |
|---|---|---|
| format | Modulation scheme | subframe, M_{bit} |
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + BPSK | 22 |

TABLE 5

| PUCCH | | |
|---|---|---|
| format | Normal CP | Extended CP |
| 1, 1a, 1b | 3 | 2 |
| 2 | 2 | 1 |
| 2a, 2b | 2 | N/A |

TABLE 6

| | |
|---|---|
| PUCCH | SC-FDMA symbol location of RS |

| format | Normal CP | Extended CP |
|---|---|---|
| 1, 1a, 1b | 2, 3, 4 | 2, 3 |
| 2, 2a, 2b | 1, 5 | 3 |

FIG. 13 shows a PUCCH format 1a and 1b structure in the case of a normal CP. FIG. 14 shows a PUCCH format 1a and 1b structure in the case of an extended CP. In the PUCCH format 1a and 1b structure, the same control information is repeated in each slot within a subframe. UEs transmit ACK/NACK signals through different resources that include orthogonal covers or orthogonal cover codes (OCs or OCCs) and different cyclic shifts (i.e., different frequency domain codes) of a Computer-Generated Constant Amplitude Zero Auto Correlation (CG-CAZAC) sequence. For example, the OCs may include orthogonal Walsh/DFT codes. When the number of CSs is 6 and the number of OCs is 3, a total of 18 UEs may be multiplexed in the same Physical Resource Block (PRB) based on a single antenna. Orthogonal sequences w0, w1, w2, and w3 may be applied to an arbitrary time domain (after FFT modulation) or an arbitrary frequency domain (before FFT modulation).

For SR and persistent scheduling, ACK/NACK resources composed of CSs, OCs and PRBs may be assigned to UEs through Radio Resource Control (RRC). For dynamic ACK/NACK and non-persistent scheduling, ACK/NACK resources may be implicitly assigned to the UE using the lowest CCE index of a PDCCH corresponding to the PDSCH.

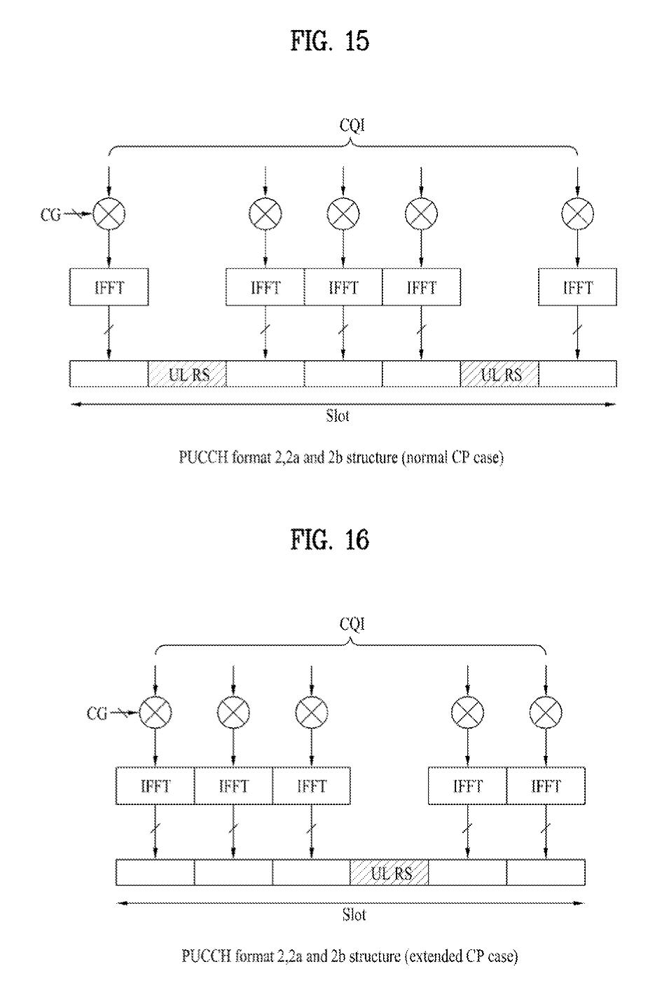

FIG. 15 shows a PUCCH format 2/2a/2b structure in the case of the normal CP. FIG. 16 shows a PUCCH format 2/2a/2b structure in the case of the extended CP. As shown in FIGS. 15 and 16, one subframe includes 10 QPSK data symbols in addition to an RS symbol in the normal CP case. Each QPSK symbol is spread in the frequency domain by a CS and is then mapped to a corresponding SC-FDMA symbol. SC-FDMA symbol level CS hopping may be applied in order to randomize inter-cell interference. RSs may be multiplexed by CDM using a CS. For example, if it is assumed that the number of available CSs is 12 or 6, 12 or 6 UEs may be multiplexed in the same PRB. For example, in PUCCH formats 1/1a/1b and 2/2a/2b, a plurality of UEs may be multiplexed by CS+OC+PRB and CS+PRB.

Length-4 and length-3 orthogonal sequences (OCs) for PUCCH formats 1/1a/1b are shown in the following Tables 7 and 8.

TABLE 7
Length-4 orthogonal sequences for PUCCH formats 1/1a/1b

| | Orthogonal sequences |
|---|---|
| Sequence index n_{oc} (nₛ) | [w(0) . . . w(N_{SF}^{PUCCH} − 1)] |
| 0 | [+1 +1 +1 +1] |
| 1 | [+1 −1 +1 −1] |
| 2 | [+1 −1 −1 +1] |

TABLE 8
Length-3 orthogonal sequences for PUCCH formats 1/1a/1b

| | Orthogonal sequences |
|---|---|
| Sequence index n_{oc} (nₛ) | [w(0) . . . w(N_{SF}^{PUCCH} − 1)] |
| 0 | [1 1 1] |
| 1 | [1 e^{j2π/3} e^{j4π/3}] |
| 2 | [1 e^{j4π/3} e^{j2π/3}] |

The orthogonal sequences (OCs) for the RS in the PUCCH formats 1/1a/1b are shown in Table 9.

TABLE 9
1a and 1b

| Sequence index n̅_{oc} (nₛ) | Normal cyclic prefix | Extended cyclic prefix |
|---|---|---|
| 0 | [1 1 1] | [1 1] |
| 1 | [1 e^{j2π/3} e^{j4π/3}] | [1 −1] |
| 2 | [1 e^{j4π/3} e^{j2π/3}] | N/A |

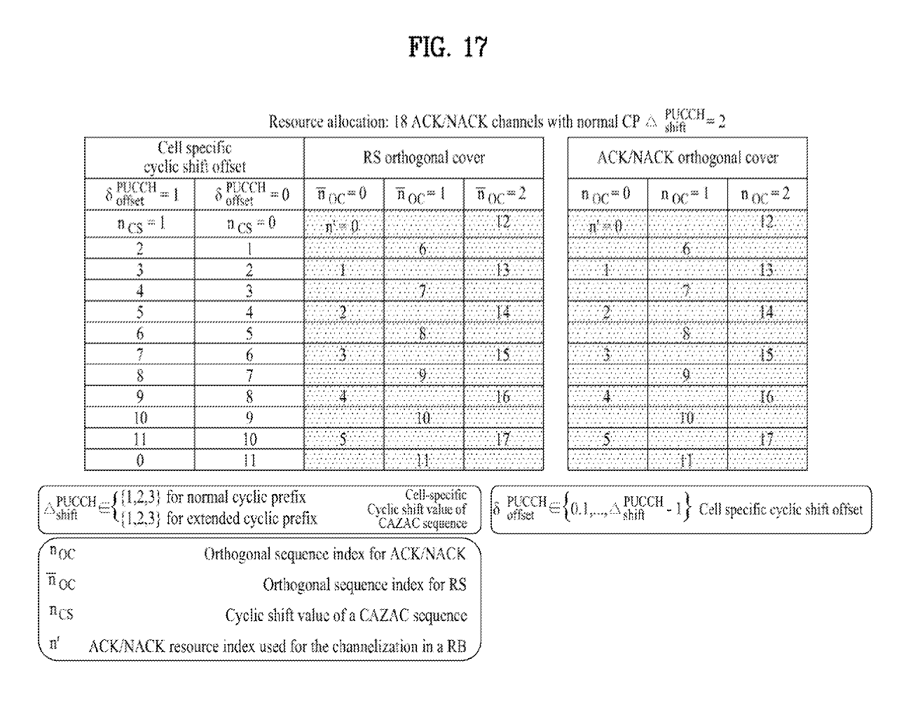

FIG. 17 illustrates ACK/NACK channelization for PUCCH formats 1a and 1b when Δ^{PUCCH}_{shift}=2.

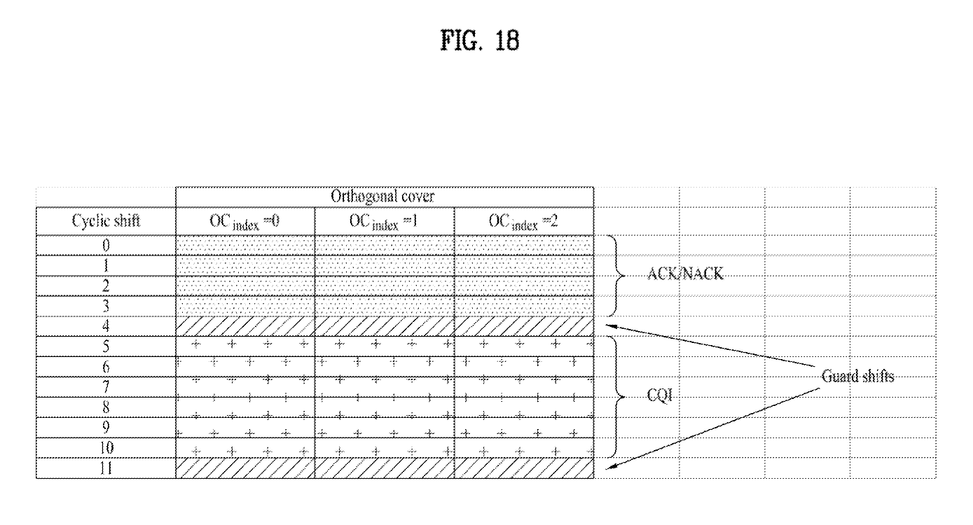

FIG. 18 illustrates channelization of a structure in which PUCCH formats 1/1a/1b and PUCCH formats 2/2a/2b are mixed within the same PRB.

CS (Cyclic Shift) hopping and OC (Orthogonal Cover) remapping may be applied as follows.

(1) Symbol-based cell-specific CS hopping for inter-cell interference randomization

(2) Slot level CS/OC remapping
1) For inter-cell interference randomization
2) Slot-based access for mapping between ACK/NACK channels and resources (k)

A resource nᵣ for PUCCH formats 1/1a/1b includes the following combination.

(1) CS (=DFT OC in a symbol level) (n_{cs})

(2) OC (OC in a slot level) (n_{cs})

(3) Frequency RB (n_{rb})

When indices representing the CS, the OC and the RB are n_{cs}, n_{oc} and n_{rb}, respectively, a representative index nᵣ includes n_{cs}, n_{oc} and n_{rb}. That is, nᵣ=(n_{cs}, n_{oc}, n_{rb}).

A CQI, a PMI, an RI, and a combination of a CQI and an ACK/NACK may be transmitted through PUCCH formats 2/2a/2b. Here, Reed Muller (RM) channel coding may be applied.

For example, in the LTE system, channel coding for a UL CQI is described as follows. A bit stream a₀, a₁, a₂, a₃, . . . , a_{A-1} is channel-coded using a (20, A) RM code. Table 10 shows a base sequence for the (20, A) code. a₀ and a_{A-1} and represent a Most Significant Bit (MSB) and a Least Significant Bit (LSB), respectively. In the extended CP case, the maximum number of information bits is 11, except when the CQI and the ACK/NACK are simultaneously transmitted. After the bit stream is coded into 20 bits using the RM code, QPSK modulation may be applied to the encoded bits. Before QPSK modulation, the encoded bits may be scrambled.

TABLE 10

| l | M_{i,0} | M_{i,1} | M_{i,2} | M_{i,3} | M_{i,4} | M_{i,5} | M_{i,6} | M_{i,7} | M_{i,8} | M_{i,9} | M_{i,10} | M_{i,11} | M_{i,12} |
|---|---|---|---|---|---|---|---|---|---|---|---|---|---|
| 0 | 1 | 1 | 0 | 0 | 0 | 0 | 0 | 0 | 0 | 0 | 1 | 1 | 0 |
| 1 | 1 | 1 | 1 | 0 | 0 | 0 | 0 | 0 | 0 | 1 | 1 | 1 | 0 |
| 2 | 1 | 0 | 0 | 1 | 0 | 0 | 1 | 0 | 1 | 1 | 1 | 1 | 1 |
| 3 | 1 | 0 | 1 | 1 | 0 | 0 | 0 | 0 | 1 | 0 | 1 | 1 | 1 |
| 4 | 1 | 1 | 1 | 1 | 0 | 0 | 0 | 1 | 0 | 0 | 1 | 1 | 1 |
| 5 | 1 | 1 | 0 | 0 | 1 | 0 | 1 | 1 | 1 | 0 | 1 | 1 | 1 |
| 6 | 1 | 0 | 1 | 0 | 1 | 0 | 1 | 0 | 1 | 1 | 1 | 1 | 1 |
| 7 | 1 | 0 | 0 | 1 | 1 | 0 | 0 | 1 | 1 | 0 | 1 | 1 | 1 |
| 8 | 1 | 1 | 0 | 1 | 1 | 0 | 0 | 1 | 0 | 1 | 1 | 1 | 1 |
| 9 | 1 | 0 | 1 | 1 | 1 | 0 | 1 | 0 | 0 | 1 | 1 | 1 | 1 |
| 10 | 1 | 0 | 1 | 0 | 0 | 1 | 1 | 1 | 0 | 1 | 1 | 1 | 1 |
| 11 | 1 | 1 | 1 | 0 | 0 | 1 | 1 | 0 | 1 | 0 | 1 | 1 | 1 |
| 12 | 1 | 0 | 0 | 1 | 0 | 1 | 0 | 1 | 1 | 1 | 1 | 1 | 1 |
| 13 | 1 | 1 | 0 | 1 | 0 | 1 | 0 | 1 | 0 | 1 | 1 | 1 | 1 |
| 14 | 1 | 0 | 0 | 0 | 1 | 1 | 0 | 1 | 0 | 0 | 1 | 0 | 1 |
| 15 | 1 | 1 | 0 | 0 | 1 | 1 | 1 | 1 | 0 | 1 | 1 | 0 | 1 |
| 16 | 1 | 1 | 1 | 0 | 1 | 1 | 1 | 0 | 0 | 1 | 0 | 1 | 1 |
| 17 | 1 | 0 | 0 | 1 | 1 | 1 | 0 | 0 | 1 | 0 | 0 | 1 | 1 |
| 18 | 1 | 1 | 0 | 1 | 1 | 1 | 1 | 1 | 0 | 0 | 0 | 0 | 0 |
| 19 | 1 | 0 | 0 | 0 | 0 | 1 | 1 | 0 | 0 | 0 | 0 | 0 | 0 |

Channel coding bits b₀, b₁, b₂, b₃, . . . , b_{B-1} may be generated by Equation 9.

$${b}_{i} = {\sum }_{n = 0}^{A - 1} ( {a}_{n} \cdot {M}_{i , n} ) mod 2 , \qquad [ Equation 9 ]$$

where i=0, 1, 2, . . . , B−1.

Table 11 shows an uplink control information (UCI) field for broadband reporting (single antenna port, transmit diversity or open loop spatial multiplexing PDSCH) CQI feedback.

TABLE 11

| Field | Bandwidth |
|---|---|
| Wideband CQI | 4 |

Table 12 shows a UCI field for wideband CQI and PMI feedback. The field reports closed loop spatial multiplexing PDSCH transmission.

TABLE 12

| | Bandwidth | | | |
|---|---|---|---|---|
| | 2 antenna ports | | 4 antenna ports | |
| Field | Rank = 1 | Rank = 2 | Rank = 1 | Rank > 1 |
| Wideband CQI | 4 | 4 | 4 | 4 |
| Spatial differential CQI | 0 | 3 | 0 | 3 |
| PMI (Precoding Matrix | 2 | 1 | 4 | 4 |
| Index) | | | | |

Table 13 shows a UCI field for RI feedback for wideband reporting.

TABLE 13

| | Bit widths | | |
|---|---|---|---|
| | | 4 antenna ports | |
| Field | 2 antenna ports | Up to two layers | Up to four layers |
| RI (Rank | 1 | 1 | 2 |
| Indication) | | | |

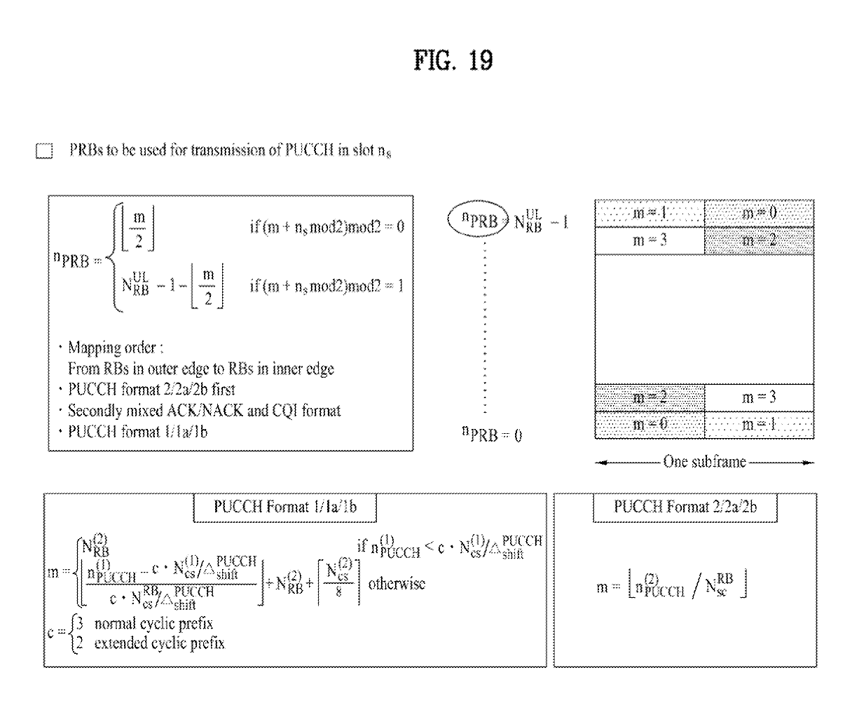

FIG. 19 shows PRB allocation. As shown in FIG. 19, the PRB may be used for PUCCH transmission in slot nₛ.

In the LTE system, PUCCH resources for ACK/NACK are not pre-allocated to each UE, and several UEs located in the cell are configured to divisionally use several PUCCH resources at every time point. In more detail, PUCCH resources used for ACK/NACK transmission of a UE may correspond to a PDCCH that carries scheduling information of the corresponding DL data. The entire region to which a PDCCH is transmitted in each DL subframe is comprised of a plurality of Control Channel Elements (CCEs), and a PDCCH transmitted to the UE is comprised of one or more CCEs. The UE may transmit ACK/NACK through PUCCH resources (e.g., first CCE) from among CCEs constructing a PDCCH received by the UE. For example, if information on a PDSCH is delivered on a PDCCH composed of CCEs #4, #5 and #6, a UE transmits an ACK/NACK signal on PUCCH #4 corresponding to CCE #4 serving as the first CCE of the PDCCH. Specifically, a PUCCH resource index in an LTE system is determined as follows.

[Equation 10]

n⁽¹⁾_{PUCCH}=n_{CCE}+N⁽¹⁾_{PUCCH}

Here, n⁽¹⁾_{PUCCH} denotes a resource index of PUCCH formats 1a/1b for transmission of ACK/NACK/DTX responses (e.g., ACK, NACK, DTX (Discontinuous Transmission)), N⁽¹⁾_{PUCCH} denotes a signaling value received from a higher layer, and n_{CCE} denotes the smallest value of CCE indexes used for PDCCH transmission. A cyclic shift (CS), an orthogonal spreading code (OC) and a Physical Resource Block (PRB) for PUCCH formats 1a/1b are obtained from n⁽¹⁾_{PUCCH}.

When the LTE system operates in TDD, a UE transmits one multiplexed ACK/NACK signal for a plurality of PDSCHs received through subframes at different timings. Specifically, the UE transmits one multiplexed ACK/NACK signal for a plurality of PDSCHs using a channel selection scheme. The channel selection scheme is also referred to as a PUCCH selection transmission scheme or ACK/NACK selection scheme. When the UE receives a plurality of DL data in the hannel selection scheme, the UE occupies a plurality of UL physical channels in order to transmit a multiplexed ACK/NACK signal. For example, when the UE receives a plurality of PDSCHs, the UE can occupy the same number of PUCCHs as the PDSCHs using a specific CCE of a PDCCH which indicates each PDSCH. In this case, the UE can transmit a multiplexed ACK/NACK signal using combination of which one of the occupied PUCCHs is selected and modulated/coded results applied to the selected PUCCH.

Table 14 shows the mapping table for the channel selection scheme defined in the LTE system.

TABLE 14

| HARQ-ACK(0), HARQ-ACK(1), | | b(0), |
|---|---|---|
| HARQ-ACK(2), HARQ-ACK(3) | n⁽¹⁾_{PUCCH, X} | b(1) |
| ACK, ACK, ACK, ACK | n⁽¹⁾_{PUCCH, 1} | 1, 1 |
| ACK, ACK, ACK, NACK/DTX | n⁽¹⁾_{PUCCH, 1} | 1, 0 |
| NACK/DTX, NACK/DTX, NACK, DTX | n⁽¹⁾_{PUCCH, 2} | 1, 1 |
| ACK, ACK, NACK/DTX, ACK | n⁽¹⁾_{PUCCH, 1} | 1, 0 |
| NACK, DTX, DTX, DTX | n⁽¹⁾_{PUCCH, 0} | 1, 0 |
| ACK, ACK, NACK/DTX, NACK/DTX | n⁽¹⁾_{PUCCH, 1} | 1, 0 |
| ACK, NACK/DTX, ACK, ACK | n⁽¹⁾_{PUCCH, 3} | 0, 1 |
| NACK/DTX, NACK/DTX, NACK/DTX, NACK | n⁽¹⁾_{PUCCH, 3} | 1, 1 |
| ACK, NACK/DTX, ACK, NACK/DTX | n⁽¹⁾_{PUCCH, 2} | 0, 1 |
| ACK, NACK/DTX, NACK/DTX, ACK | n⁽¹⁾_{PUCCH, 0} | 0, 1 |
| ACK, NACK/DTX, NACK/DTX, NACK/DTX | n⁽¹⁾_{PUCCH, 0} | 1, 1 |
| NACK/DTX, ACK, ACK, ACK | n⁽¹⁾_{PUCCH, 3} | 0, 1 |
| NACK/DTX, NACK, DTX, DTX | n⁽¹⁾_{PUCCH, 1} | 0, 0 |
| NACK/DTX, ACK, ACK, NACK/DTX | n⁽¹⁾_{PUCCH, 2} | 1, 0 |
| NACK/DTX, ACK, NACK/DTX, ACK | n⁽¹⁾_{PUCCH, 3} | 1, 0 |
| NACK/DTX, ACK, NACK/DTX, NACK/DTX | n⁽¹⁾_{PUCCH, 1} | 0, 1 |
| NACK/DTX, NACK/DTX, ACK, ACK | n⁽¹⁾_{PUCCH, 3} | 0, 1 |
| NACK/DTX, NACK/DTX, ACK, NACK/DTX | n⁽¹⁾_{PUCCH, 2} | 0, 0 |
| NACK/DTX, NACK/DTX, NACK/DTX, ACK | n⁽¹⁾_{PUCCH, 3} | 0, 0 |
| DTX, DTX, DTX, DTX | N/A | N/A |

In Table 14, HARQ-ACK(i) indicates the ACK/NACK/DTX result of an i-th data unit (0≦I≦3). ACK/NACK/DTX responses include ACK, NACK, DTX, or NACK/DTX. NACK/DTX means NACK or DTX. DTX (Discontinuous Transmission) represents that there is no transmission of a data unit (e.g., a transport block TB) corresponding to HARQ-ACK(i) or the UE does not detect the data unit corresponding to HARQ-ACK(i). Maximum 4 PUCCH resources (i.e., n⁽¹⁾_{PUCCH,0} to n⁽¹⁾_{PUCCH,3}) can be occupied for each data unit. For a plurality of HARQ-ACKs (i.e., A/N codewords), one PUCCH resource is selected from a plurality of PUCCH resources and is transmitted on PUCCH resource where b(0)b(1) is selected. In Table 14, n⁽¹⁾_{PUCCH,X} represents a PUCCH resource (e.g., PUCCH format 1b resource) for transmitting a plurality of HARQ-ACK signals. b(0)b(1) indicates two bits transmitted through the selected PUCCH resource, which are modulated using QPSK. For example, when the UE has decoded 4 data units successfully, the UE transmits bits (1, 1) to a BS through a PUCCH resource linked with n⁽¹⁾_{PUCCH,1}. Since combinations of PUCCH resources and QPSK symbols cannot represent all available ACK/NACK suppositions, NACK and DTX are coupled except some cases (NACK/DTX, N/D).

The term “multi-carrier system” or “carrier aggregation system” refers to a system for aggregating and utilizing a plurality of carriers having a bandwidth smaller than a target bandwidth for broadband support. When a plurality of carriers having a bandwidth smaller than a target bandwidth is aggregated, the bandwidth of the aggregated carriers may be limited to a bandwidth used in the existing system for backward compatibility with the existing system. For example, the existing LTE system may support bandwidths of 1.4, 3, 5, 10, 15 and 20 MHz and an LTE-Advanced (LTE-A) system evolved from the LTE system may support a bandwidth greater than 20 MHz using only the bandwidths supported by the LTE system. Alternatively, regardless of the bandwidths used in the existing system, a new bandwidth may be defined so as to support carrier aggregation. The term “multi-carrier” may be used interchangeably with the terms “carrier aggregation” and “bandwidth aggregation”. The term “carrier aggregation” may refer to both contiguous carrier aggregation and non-contiguous carrier aggregation.

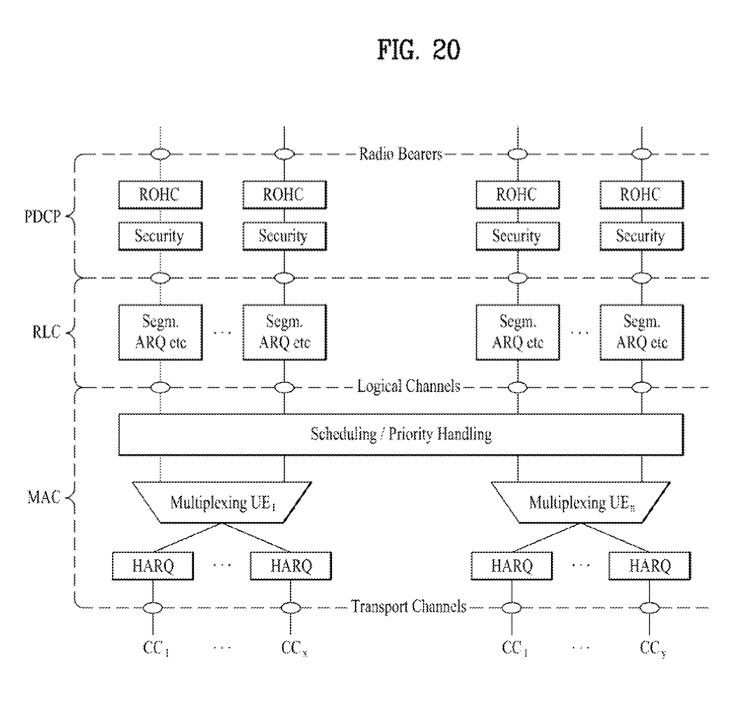

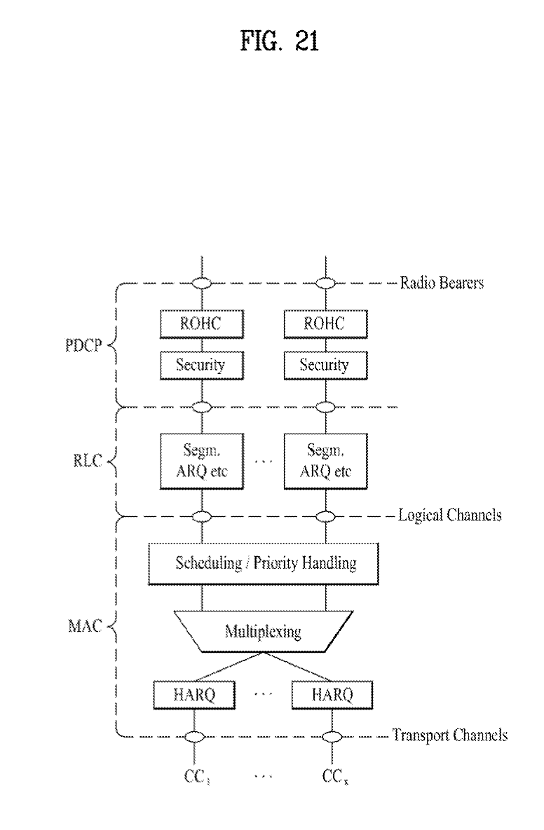

FIG. 20 is a conceptual diagram illustrating management of downlink component carriers (DL CCs) in a base station (BS) and FIG. 21 is a conceptual diagram illustrating management of uplink component carriers (UL CCs) in a user equipment (UE). For ease of explanation, the higher layer is simply described as a MAC (or a MAC entity) in the following description of FIGS. 20 and 21.

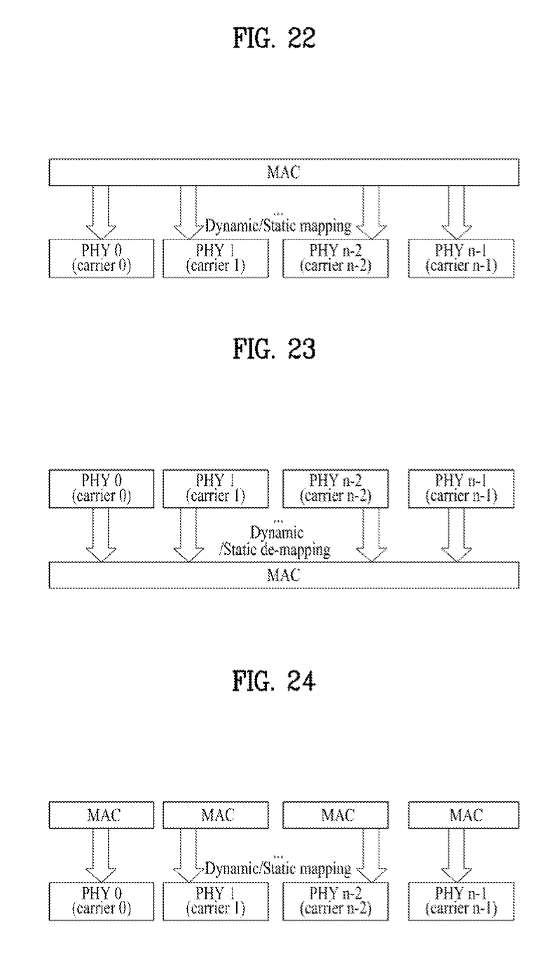

FIG. 22 is a conceptual diagram illustrating management of multiple carriers by one MAC entity in a BS. FIG. 23 is a conceptual diagram illustrating management of multiple carriers by one MAC entity in a UE.

As shown in FIGS. 22 and 23, one MAC manages and operates one or more frequency carriers to perform transmission and reception. Frequency carriers managed by one MAC need not be contiguous and as such they are more flexible in terms of resource management. In FIGS. 22 and 23, it is assumed that one PHY (or PHY entity) corresponds to one component carrier (CC) for ease of explanation. One PHY does not always indicate an independent radio frequency (RF) device. Although one independent RF device generally corresponds to one PHY, the present invention is not limited thereto and one RF device may include a plurality of PHYs.

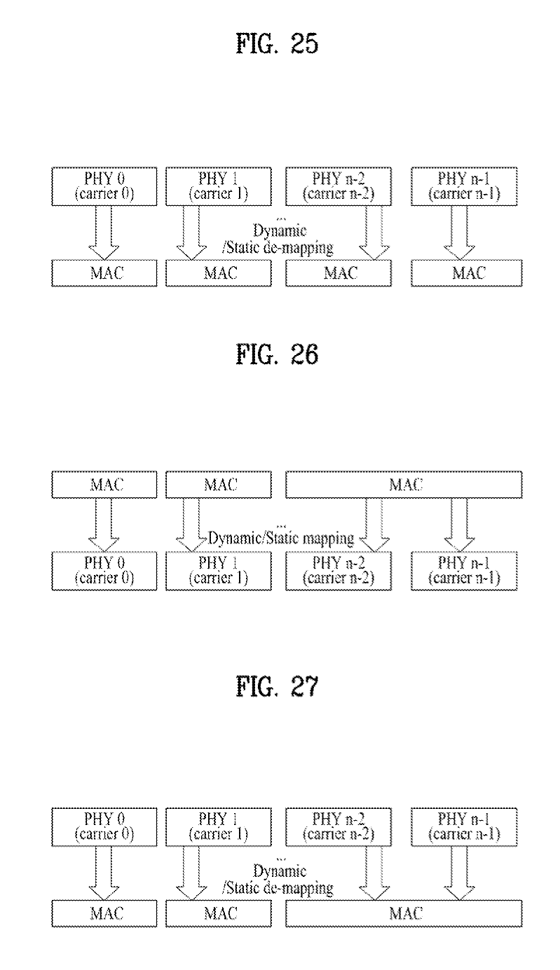

FIG. 24 is a conceptual diagram illustrating management of multiple carriers by a plurality of MAC entities in a BS. FIG. 25 is a conceptual diagram illustrating management of multiple carriers by a plurality of MAC entities in a UE. FIG. 26 illustrates another scheme of management of multiple carriers by a plurality of MAC entities in a BS. FIG. 27 illustrates another scheme of management of multiple carriers by a plurality of MAC entities in a UE.

Unlike the structures of FIGS. 22 and 23, a number of carriers may be controlled by a number of MAC entities rather than by one MAC as shown in FIGS. 24 to 27.

As shown in FIGS. 24 and 25, carriers may be controlled by MACs on a one to one basis. As shown in FIGS. 26 and 27, some carriers may be controlled by MACs on a one to one basis and one or more remaining carriers may be controlled by one MAC.

The above-mentioned system includes a plurality of carriers (i.e., 1 to N carriers) and carriers may be used so as to be contiguous or non-contiguous to each other. This scheme may be equally applied to UL and DL. The TDD system is constructed so as to manage N carriers, each including downlink and uplink transmission, and the FDD system is constructed such that multiple carriers are applied to each of uplink and downlink. The FDD system may also support asymmetrical carrier aggregation in which the numbers of carriers aggregated in uplink and downlink and/or the bandwidths of carriers in uplink and downlink are different.

When the number of component carriers (CCs) aggregated in uplink (UL) is identical to the number of CCs aggregated in downlink (DL), all CCs may be configured so as to be compatible with the conventional system. However, this does not mean that CCs that are configured without taking into consideration such compatibility are excluded from the present invention.

Hereinafter, it is assumed for ease of explanation description that, when a PDCCH is transmitted through DL component carrier #0, a PDSCH corresponding to the PDCCH is transmitted through DL component carrier #0. However, it is apparent that cross-carrier scheduling may be applied such that the PDSCH is transmitted through a different DL component carrier. The term “component carrier” may be replaced with other equivalent terms (e.g., cell).

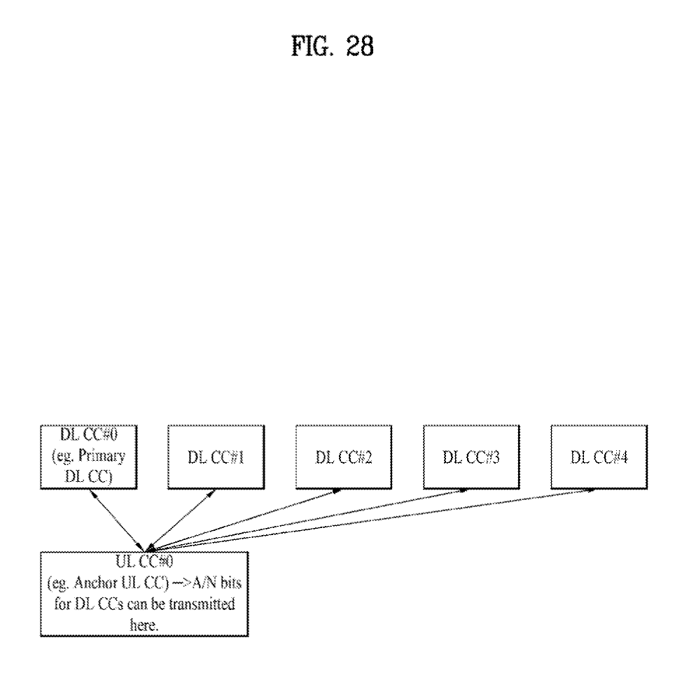

FIG. 28 shows a scenario in which uplink control information (UCI) is transmitted in a radio communication system supporting carrier aggregation (CA). For ease of explanation, it is assumed in this example that the UCI is ACK/NACK (A/N). However, the UCI may include control information such as channel state information (CSI) (e.g., CQI, PMI, RI, etc.) or scheduling request information (e.g., SR, etc.).

FIG. 28 shows asymmetric carrier aggregation in which 5 DL CCs and one UL CC are linked. The illustrated asymmetric carrier aggregation may be set from the viewpoint of UCI transmission. That is, a DL CC-UL CC linkage for UCI and a DL CC-UL CC linkage for data may be set differently. When it is assumed for ease of explanation that one DL CC can carry up to two codewords, at least two ACK/NACK bits are needed. In this case, in order to transmit an ACK/NACK for data received through 5 DL CCs through one UL CC, at least 10 ACK/NACK bits are needed. In order to also support a discontinuous transmission (DTX) state for each DL CC, at least 12 bits (=5⁵=3125=11.61 bits) are needed for ACK/NACK transmission. The conventional PUCCH format 1a/1b structure cannot transmit such extended ACK/NACK information since the conventional PUCCH format 1a/1b structure can transmit up to 2 ACK/NACK bits. Although carrier aggregation has been illustrated as a cause of an increase in the amount of UCI information, the amount of UCI information may also be increased due to an increase in the number of antennas and the presence of a backhaul subframe in a TDD system or a relay system. Similar to the case of ACK/NACK, the amount of control information that should be transmitted is increased even when control information associated with a plurality of DL CCs is transmitted through one UL CC. For example, UCI payload may be increased when there is a need to transmit a CQI/PMI/RI for a plurality of DL CCs. DL CC may also be referred to as DL Cell, and UL CC may also be referred to as UL Cell. In addition, the anchor (or primary) DL CC may also be referred to as DL PCell, and the anchor (or primary) UL CC may also be referred to as UL PCell.

A DL primary CC may be defined as a DL CC linked with a UL primary CC. Here, linkage includes implicit and explicit linkage. In LTE, one DL CC and one UL CC are uniquely paired. For example, a DL CC that is linked with a UL primary CC by LTE pairing may be referred to as a DL primary CC. This may be regarded as implicit linkage. Explicit linkage indicates that a network configures the linkage in advance and may be signaled by RRC or the like. In explicit linkage, a DL CC that is paired with a UL primary CC may be referred to as a primary DL CC. A UL primary (or anchor) CC may be a UL CC in which a PUCCH is transmitted. Alternatively, the UL primary CC may be a UL CC in which UCI is transmitted through a PUCCH or a PUSCH. The DL primary CC may also be configured through higher layer signaling. The DL primary CC may be a DL CC in which a UE performs initial access. DL CCs other than the DL primary CC may be referred to as DL secondary CCs. Similarly, UL CCs other than the UL primary CC may be referred to as UL secondary CCs.

LTE-A uses the concept of a cell so as to manage radio resources. The cell is defined as a combination of DL resources and UL resources. Here, the UL resources are not essential. Accordingly, the cell can be configured with DL resources only, or DL resources and UL resources. When CA is supported, the linkage between a carrier frequency (or DL CC) of a DL resource and a carrier frequency (or UL CC) of a UL resource can be designated by system information. A cell operating at a primary frequency (or PCC) can be referred to as a Primary Cell (PCell) and a cell operating at a secondary frequency (or SCC) can be referred to as a Secondary Cell (SCell). The PCell is used for a UE to perform an initial connection establishment procedure or a connection re-establishment procedure. The PCell may refer to a cell designated during a handover procedure. The SCell can be configured after RRC connection is established and used to provide additional radio resources. The PCell and the SCell can be called a serving cell. Accordingly, for a UE that does not support CA while in an RRC_Connected state, only one serving cell configured with a PCell exists. Conversely, for a UE that is in an RRC_Connected state and supports CA, one or more serving cells including a PCell and an SCell are provided. For CA, a network can configure one or more SCells for a UE that supports CA in addition to a PCell initially configured during a connection establishment procedure after an initial security activation procedure.

DL-UL pairing may correspond only to FDD. DL-UL pairing may not be defined for TDD since TDD uses the same frequency. In addition, a DL-UL linkage may be determined from a UL linkage through UL E-UTRA Absolute Radio Frequency Channel Number (EARFCN) of SIB2. For example, the DL-UL linkage may be acquired through SIB2 decoding when initial access is performed or through RRC signaling otherwise. Accordingly, only the SIB2 linkage may be present and other DL-UL pairing may not be defined. For example, in the 5DL:1UL structure of FIG. 28, DL CC #0 and UL CC #0 may be in an SIB2 linkage relation with each other and other DL CCs may be in an SIB2 linkage relation with other UL CCs which have not been set for the UE.

While some embodiments are focused on asymmetrical carrier aggregation, the present invention can be applied to various carrier aggregation scenarios including symmetrical carrier aggregation.

When transmitting ACK/NACK in a carrier aggregation (CA) supported system, the following CA PUCCH formats can be constructed according to A/N bits (or the number of configured DL CCs, the number of activated DL CCs, and the number of scheduled DL CCs) to be transmitted.
LTE-A UE that supports x ACK/NACK bits or less: PUCCH format 1b with channel selection
LTE-A UE that supports more than x A/N bits: DFT-S-OFDMA (Discrete Fourier Transform Spread Orthogonal Frequency division Multiplexing) PUCCH format, where x=4.

As can be seen from Table 14, the channel selection scheme is designed to transmit information by combining a constellation point of data with selection of multiple resources defined for (RS+data). Tables 15 and 16 exemplarily show the mapping tables for channel selection. Table 15 exemplarily shows the mapping table for 3-bit ACK/NACK, and Table 16 exemplarily shows the mapping table for 4-bit ACK/NACK.

TABLE 15

| | |
|---|---|
| Ch1 | Ch2 |

| A/N codeword | RS | Data | RS | Data |
|---|---|---|---|---|
| N, N, N | 1 | 1 | 0 | 0 |
| N, N, A | 1 | −j | 0 | 0 |
| N, A, N | 1 | j | 0 | 0 |
| N, A, A | 1 | −1 | 0 | 0 |
| A, N, N | 0 | 0 | 1 | 1 |
| A, N, A | 0 | 0 | 1 | −j |
| A, A, N | 0 | 0 | 1 | j |
| A, A, A | 0 | 0 | 1 | −1 |

TABLE 16

| | Ch 1 | | Ch, 2 | | Ch 3 | | Ch4 | |
|---|---|---|---|---|---|---|---|---|
| A/N codeword | RS | Data | RS | Data | RS | Data | RS | Data |
| N, N, N, N | 1 | 1 | 0 | 0 | 0 | 0 | 0 | 0 |
| N, N, N, A | 1 | −j | 0 | 0 | 0 | 0 | 0 | 0 |
| N, N, A, N | 1 | j | 0 | 0 | 0 | 0 | 0 | 0 |
| N, N, A, A | 1 | −1 | 0 | 0 | 0 | 0 | 0 | 0 |
| N, A, N, N | 0 | 0 | 1 | 1 | 0 | 0 | 0 | 0 |
| N, A, N, A | 0 | 0 | 1 | −j | 0 | 0 | 0 | 0 |
| N, A, A, N | 0 | 0 | 1 | J | 0 | 0 | 0 | 0 |
| N, A, A, A | 0 | 0 | 1 | −1 | 0 | 0 | 0 | 0 |
| A, N, N, N | 0 | 0 | 0 | 0 | 1 | 1 | 0 | 0 |
| A, N, N, A | 0 | 0 | 0 | 0 | 1 | −j | 0 | 0 |
| A, N, A, N | 0 | 0 | 0 | 0 | 1 | j | 0 | 0 |
| A, N, A, A | 0 | 0 | 0 | 0 | 1 | −1 | 0 | 0 |
| A, A, N, N | 0 | 0 | 0 | 0 | 0 | 0 | 1 | 1 |
| A, A, N, A | 0 | 0 | 0 | 0 | 0 | 0 | 1 | −j |
| A, A, A, N | 0 | 0 | 0 | 0 | 0 | 0 | 1 | j |
| A, A, A, A | 0 | 0 | 0 | 0 | 0 | 0 | 1 | −1 |

In Tables 14 and 16, A/N codeword (CW)includes a plurality of HARQ-ACKs. Each HARQ-ACK denotes ACK/NACK/DTX responses for downlink (DL) transmission. DL transmission includes a PDSCH or a PDCCH (e.g., SPS (semi-persistent scheduling) release PDCCH) without a corresponding PDSCH. ACK/NACK/DTX response may include ACK, NACK, DTX or NACK/DTX. NACK/DTX indicates NACK or DTX. A data column denotes a modulation value corresponding to A/N codewords (i.e., a plurality of HARQ-ACKs). Tables 15 and 16 assume QPSK modulation. Each HARQ-ACK denotes ACK/NACK/DTX response for downlink transmission. DL transmission includes a PDSCH or a PDCCH (e.g., SPS release PDCCH) without a corresponding PDSCH. ACK/NACK/DTX response includes ACK, NACK, DTX or NACK/DTX. NACK/DTX indicates NACK or DTX. ChX denotes an X-th PUCCH resource (e.g., PUCCH 1b resource: n⁽¹⁾_{PUCCH}) occupied for channel selection. ChX may be implicitly given as shown in Equation 10, or may be explicitly given through DCI on PDCCH. A modulation value (or 2-bit value, i.e., b(0)b(1)) corresponding to the A/N codeword (i.e., a plurality of HARQ-ACKs) is transmitted on uplink through the selected ChX. Meanwhile, RS column denotes a modulation value loaded on the demodulated RS for PUCCH.

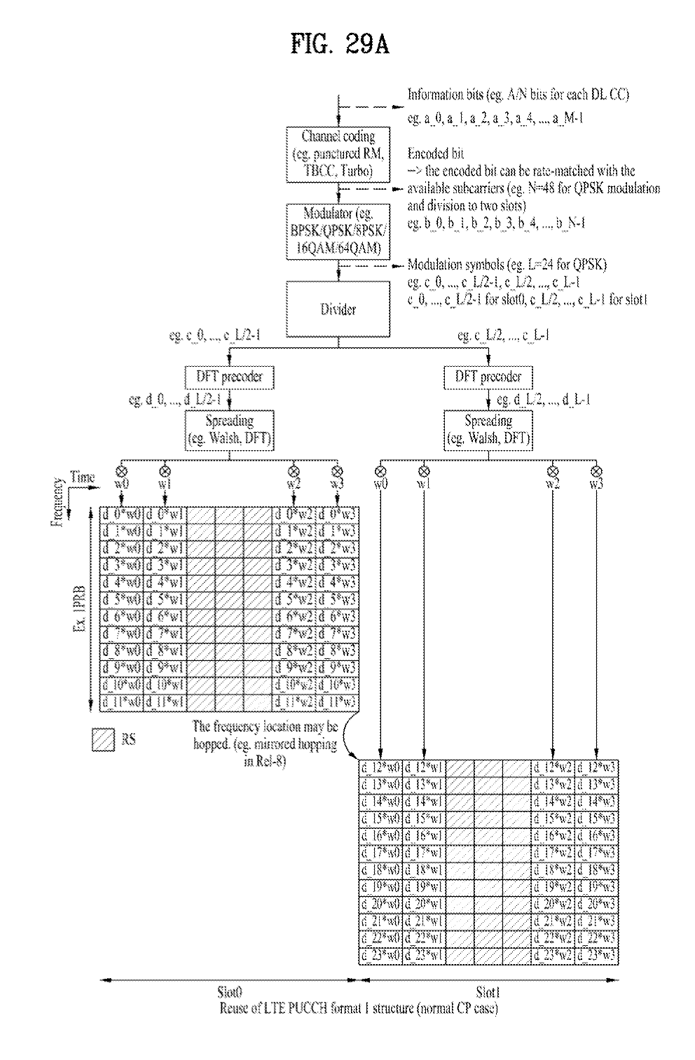

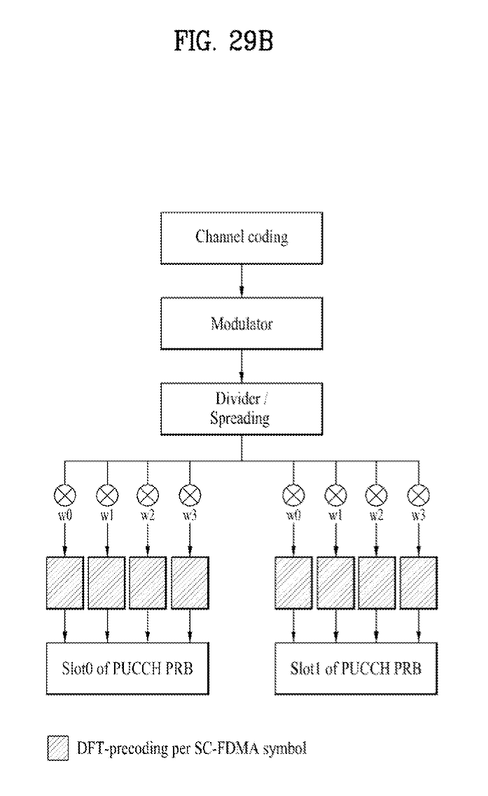

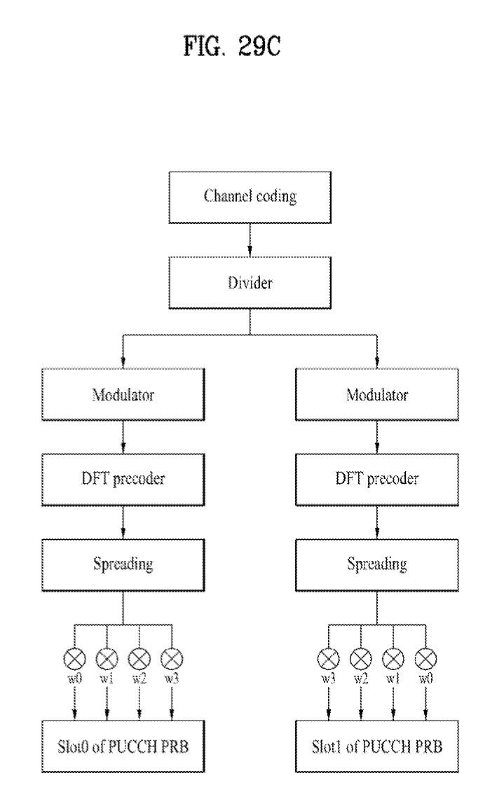

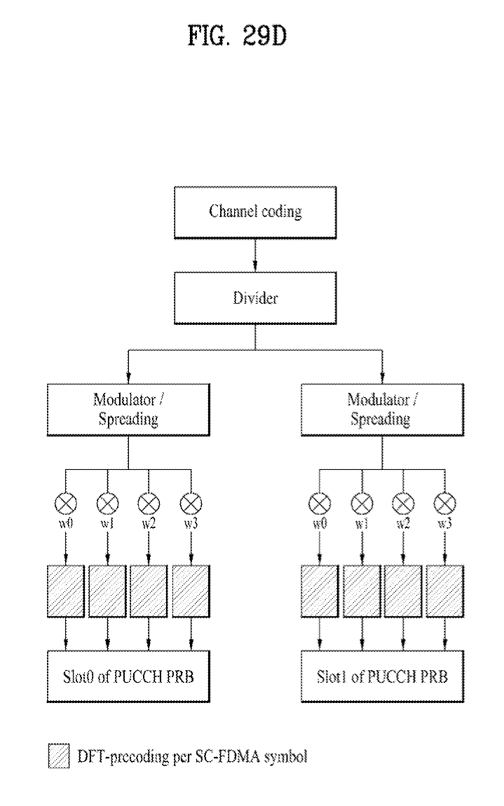

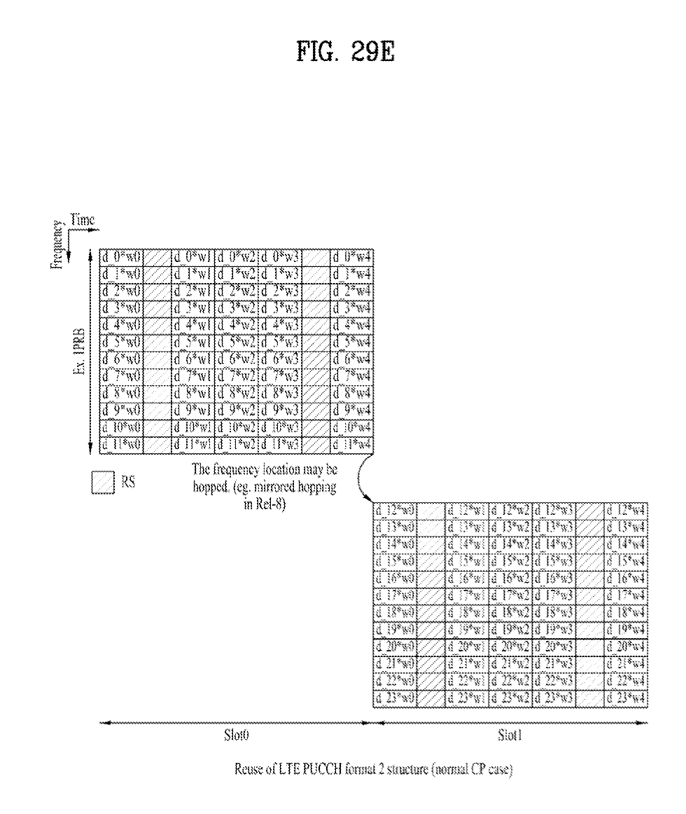

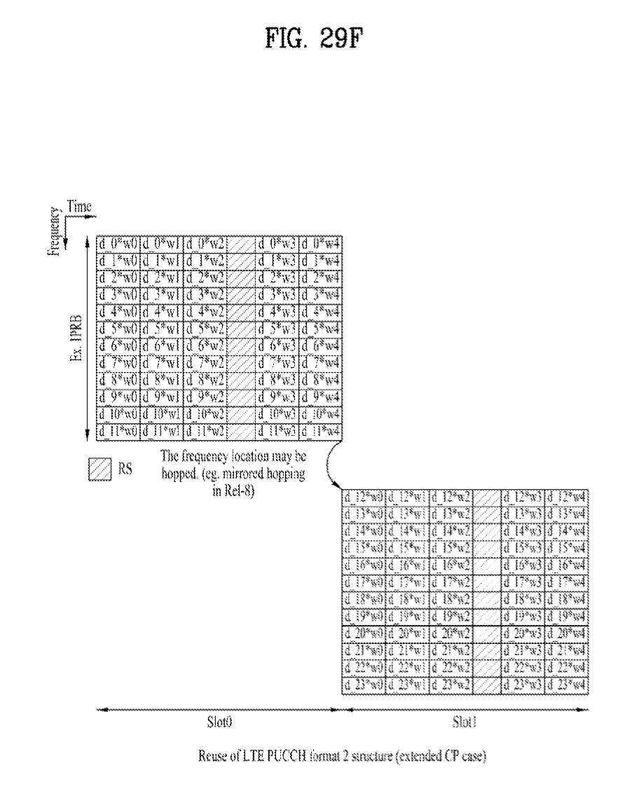

FIGS. 29A to 29F are conceptual diagrams illustrating a DFT-S-OFDMA format structure and associated signal processing according to the embodiments of the present invention.

FIG. 29A illustrates a DFT-S-OFDM PUCCH format applied to PUCCH format 1 (normal CP). Referring to FIG. 29A, a channel coding block performs channel coding on information bits (a_{—}0, a_{—}1, . . . , a_M−1) (e.g., multiple ACK/NACK bits) to generate encoded bits (coded bits or coding bits) (or codeword) (b_{—}0, b_{—}1, . . . , a_N−1). Here, M represents the size of the information bits, and N represents the size of the coding bits. The information bits may include UCI, for example, multiple ACKs/NACKs for multiple data (or PDSCHs) received through multiple DL CCs. Here, the information bits (a_{—}0, a_{—}1, . . . , a_M−1) are joint-coded regardless of type, number, or size of UCIs that constitute the information bits. For example, when the information bits include multiple ACK/NACK data for a plurality of DL CCs, channel coding is not performed per DL CC or per ACK/NACK bit but is instead performed for the entire bit information, thereby generating a single codeword. Channel coding may include, without being limited to, simple repetition, simplex coding, Reed-Muller (RM) coding, punctured RM coding, tail-biting convolutional coding (TBCC), low-density parity-check (LDPC) or turbo-coding. Although not shown in the drawings, the encoded bits may be rate-matched taking into consideration modulation order and the amount of resources. The rate matching function may be incorporated into the channel coding block or may be performed through a separate functional block.

A modulator modulates the coded bits (b_{—}0, b_{—}1, . . . , b_N−1) to generate modulation symbols (c_{—}0, c_{—}1, . . . , c_L−1). L is the size of the modulation symbols. The modulation method is performed by modifying the size and phase of a transmission (Tx) signal. For example, the modulation method includes n-PSK (Phase Shift Keying) and n-QAM (Quadrature Amplitude Modulation), where n is an integer greater than 1. Specifically, the modulation method may include Binary PSK (BPSK), Quadrature PSK (QPSK), 8-PSK, QAM, 16-QAM, 64-QAM, etc.

A divider distributes the modulation symbols (c_{—}0, c_{—}1, . . . , c_L−1) to slots. The order/pattern/scheme for distributing the modulation symbols to slots are not specifically limited. For example, the divider may sequentially distribute the modulation symbols to slots in order of increasing slot number (according to a localized scheme). In this case, as shown in the drawings, the modulation symbols (c_{—}0, c_{—}1, . . . , c_L/2−1) may be distributed to slot 0 and the modulation symbols (c_L/2, c_L/2+1, . . . , c_L−1) may be distributed to slot 1. In addition, the modulation symbols may be interleaved (or permuted) when they are distributed to slots. For example, even modulation symbols may be distributed to slot 0 and odd modulation symbols may be distributed to slot 1. The modulation process and the division process may be performed in reverse order.

A DFT precoder performs DFT precoding (e.g., 12-point DFT) for the modulation symbols distributed to individual slots so as to generate a single carrier waveform. Referring to the drawings, the modulation symbols (c_{—}0, c_{—}1, . . . , c_L/2−1) distributed to Slot 0 may be DFT-precoded to DFT symbols (d_{—}0, d_{—}1, . . . , d_L/2−1), and the modulation symbols (c_L/2, c_L/2+1, . . . , c_L−1) ) distributed to Slot 1 may be DFT-precoded to DFT symbols (d_L/2, d_L/2+1, . . . , d_L−1) ). The DFT precoding may be replaced with another linear operation (e.g., Walsh precoding).

The spreading block performs (time domain) spreading of the DFT-processed signal at the SC-FDMA symbol level. Time domain spreading at the SC-FDMA symbol level may be performed using the spreading code (sequence). The spreading code may include a quasi-orthogonal code and an orthogonal code. The quasi-orthogonal code is not limited thereto, and may include a PN (Pseudo Noise) code as necessary. The orthogonal code is not limited thereto, and may include a Walsh code, a DFT code, etc. as necessary. Although the present embodiment is focused only upon the orthogonal code as a representative spreading code for convenience of description, the orthogonal code may be replaced with a quasi-orthogonal code. A maximum value of the spreading code size (or the spreading factor (SF)) is limited by the number of SC-FDMA symbols used for control information transmission. For example, if four SC-FDMA symbols are used to transmit control information in one slot, (quasi-) orthogonal codes (w0, w1, w2, w3) each having a length of 4 may be used in each slot. SF means the spreading degree of control information, and may be relevant to the UE multiplexing order or antenna multiplexing order. SF may be changed according to system requirements, for example, in the order of 1→2→3→4, . . . . The SF may be pre-defined between the BS and the UE, or may be transferred to the UE through DCI or RRC signaling. For example, if one of SC-FDMA symbols for control information is punctured to achieve SRS transmission, the SF-reduced spreading code (e.g., SF=3 spreading code instead of SF=4 spreading code) may be applied to control information of the corresponding slot.

The signal generated through the above-mentioned process may be mapped to subcarriers contained in the PRB, IFFT-processed, and then converted into a time domain signal. The CP may be added to the time domain signal, and the generated SC-FDMA symbol may be transmitted through the RF unit.

Each procedure is described below in more detail on the assumption that ACK/NACK information for 5 DL CCs is transmitted. When each DL CC can transmit two PDSCHs, a corresponding ACK/NACK may be 12 bits provided that a DTX state is included. Assuming that QPSK modulation and time spreading of SF=4 are applied, the coding block size (after rate matching) may be 48 bits. The coded bits are modulated into 24 QPSK symbols and 12 QPSK symbols are distributed to each slot. In each slot, 12 QPSK symbols are converted into 12 DFT symbols through a 12-point DFT operation. 12 DFT symbols of each slot are spread and mapped to four SC-FDMA symbols using the spread code of SF=4 in the time domain. Since 12 bits are transmitted through 2 bits×12 subcarriers×8 SC-FDMA symbols, the coding rate is 0.0625 (=12/192). In the case of SF=4, up to four UEs may be multiplexed per PRB.

The signal processing procedure described with reference to FIG. 29A is only exemplary and the signal mapped to the PRB in FIG. 29A may be obtained using various equivalent signal processing procedures. The signal processing procedures equivalent to that of FIG. 29A are described below with reference to FIGS. 29B to 29G.

The signal processing procedure of FIG. 29B is different from that of FIG. 29A in the order in which the processes of the DFT precoder and the spreading block are performed. In FIG. 29A, the function of the spreading block is equivalent to multiplication of a DFT symbol stream output from the DFT precoder by a specific constant at an SC-FDMA symbol level and therefore the value of the signal mapped to the SC-FDMA symbols is equal even when the order of the processes of the DFT precoder and the spreading block is reversed. Accordingly, the signal processing procedure for DFT-S-OFDM PUCCH format may be performed in order of channel coding, modulation, division, spreading, and DFT precoding. In this case, the division process and the spreading process may be performed by one functional block. For example, the modulation symbols may be spread at the SC-FDMA symbol level while being alternately divided to slots. In another example, when the modulation symbols are divided to individual slots, the modulation symbols are copied so as to correspond to the size of the spreading code and the modulation symbols may be multiplied respectively by the elements of the spreading code. Accordingly, the modulation symbol stream generated for each slot is spread to a plurality of SC-FDMA symbols at the SC-FDMA symbol level. Thereafter, the complex symbol stream corresponding to each SC-FDMA symbol is DFT-precoded on an SC-FDMA symbol basis.

The signal processing procedure of FIG. 29C is different from that of FIG. 29A in the order in which the processes of the modulator and the divider are performed. Accordingly, the signal processing procedure for DFT-S-OFDM PUCCH format may be performed in the order of joint channel coding and division at a subframe level and then modulation, DFT precoding and spreading at each slot level.

The signal processing procedure of FIG. 29D is different from that of FIG. 29C in the order in which the processes of the DFT precoder and the spreading block are performed. As described above, the function of the spreading block is equivalent to multiplication of a DFT symbol stream output from the DFT precoder by a specific constant at an SC-FDMA symbol level and therefore the value of the signal mapped to the SC-FDMA symbols is equal even when the order of the processes of the DFT precoder and the spreading block is reversed. Accordingly, the signal processing procedure for DFT-S-OFDM PUCCH format is performed in the order of joint channel coding and division at the subframe level and then modulation at each slot level. The modulation symbol stream generated for each slot is spread to a plurality of SC-FDMA symbols at the SC-FDMA symbol level and the modulation symbol stream corresponding to each SC-FDMA symbol is DFT-precoded on an SC-FDMA symbol basis. In this case, the modulation process and the spreading process may be performed by one functional block. In one example, the generated modulation symbols may be directly spread at the SC-FDMA symbol level while the encoded bits are modulated. In another example, when the encoded bits are modulated and the modulation symbols, the modulation symbols are copied so as to correspond to the size of the spreading code and the modulation symbols may be multiplied by the elements of the spreading code on a one to one basis.

FIG. 29E shows the case in which the DFT-S-OFDM PUCCH format is applied to the structure of PUCCH format 2 (normal CP) and FIG. 29F shows the case in which the DFT-S-OFDM PUCCH format is applied to the structure of PUCCH format 2 (extended CP). The basic signal processing procedure is identical to those described with reference to FIGS. 29A to 29D. Since the structure of PUCCH format 2 of the legacy LTE is reused, the number/locations of UCI SC-FDMA symbols and RS SC-FDMA symbols in the DFT-S-OFDM PUCCH format are different from those of FIG. 29A.

Table 17 shows the location of the RS SC-FDMA symbol in the DFT-S-OFDM PUCCH format. Here, it is assumed that the number of SC-FDMA symbols in a slot is 7 (indices 0 to 6) in the normal CP case and the number of SC-FDMA symbols in a slot is 6 (indices 0 to 5) in the extended CP case.

TABLE 17

| | SC-FDMA symbol location of RS | | |
|---|---|---|---|
| | Normal CP | Extended CP | Note |
| DFT-S-OFDM | 2, 3, 4 | 2, 3 | PUCCH format 1 |
| PUCCH format 3 | | | is reused |
| | 1, 5 | 3 | PUCCH format 2 |
| | | | is reused |

Tables 18 and 19 show exemplary spread codes according to SF value. Table 18 shows DFT codes with SF=5 and SF=3 and Table 19 shows Walsh codes with SF=4 and SF=2. A DFT code is an orthogonal code represented by w̅ₘ=[w₀, w₁ . . . wₖ₋₁], where wₖ=exp(j2πkm/SF) where k denotes a DFT code size or SF value and m is 0,1, . . . , SF−1. Tables 18 and 19 show a case in which m is used as an index for an orthogonal code.

TABLE 18

Orthogonal code w̅ₘ = [w₀ w₁ . . . wₖ₋₁]

| Index m | SF = 5 | SF = 3 |
|---|---|---|
| 0 | [1 1 1 1 1] | [1 1 1] |
| 1 | [1 e^{j2π/5} e^{j4π/5} e^{j6π/5} e^{j8π/5}] | [1 e^{j2π/3} e^{j4π/3}] |
| 2 | [1 e^{j4π/5} e^{j8π/5} e^{j2π/5} e^{j6π/5}] | [1 e^{j4π/3} e^{j2π/3}] |
| 3 | [1 e^{j6π/5} e^{j2π/5} e^{j8π/5} e^{j4π/5}] | |
| 4 | [1 e^{j8π/5} e^{j6π/5} e^{j4π/5} e^{j2π/5}] | |

TABLE 19

Orthogonal code

| Index m | SF = 4 | SF = 2 |
|---|---|---|
| 0 | [+1 +1 +1 +1] | [+1 +1] |
| 1 | [+1 −1 +1 −1] | [+1 −1] |
| 2 | [+1 +1 −1 −1] | |
| 3 | [+1 −1 −1 +1] | |

On the other hand, generally, information capacity that can be transmitted in the channel selection scheme linearly increases as the number of used channels increases. For example, assuming that QPSK modulation is used for transmission of 2-bit A/N, a minimum of two channels (4=2*2) is needed. 3-bit A/N requires a minimum of two channels (8=4*2), and 4-bit A/N requires a minimum of four channels (16=4*4). Provided that information bits are denoted by N_info and the number of constellation states used in the channel is M, a minimum number of required channels is determined by a minimum number K that satisfies 2̂N_info<=M*K.

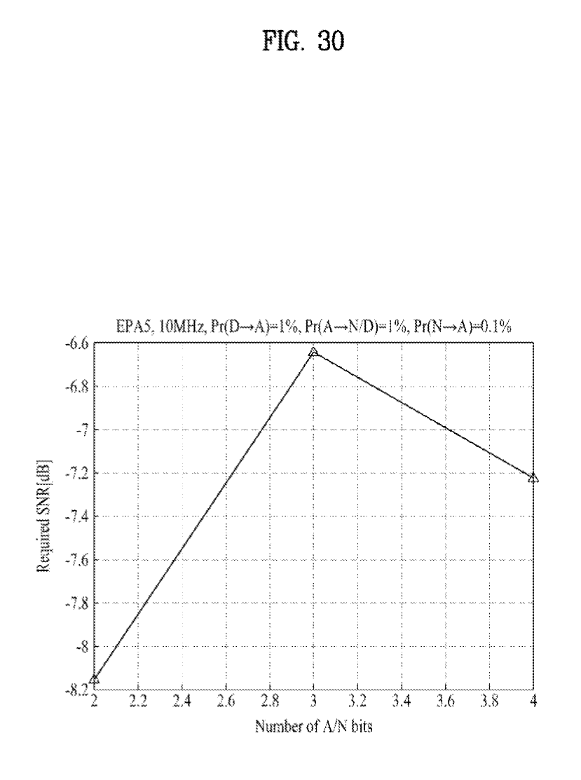

FIG. 30 shows ACK/NACK performance according to the channel selection scheme. FIG. 30 exemplarily shows ACK/NACK performance according to the number of ACK/NACK bits for use in the channel selection scheme. The simulation condition is as follows.
EPA (Extended Pedestrian A model) channel, BW 10 MHz, 1 Tx−2 Rx
Required SNR[dB]: (Probability, Pr) (DTX->ACK)<=1%, Pr(miss ACK)<=1%, Pr(NACK->ACK)<=0.1%
Used PUCCH resources (channels)—The use of a minimum number of required channels
2-bit ACK/NACK: 2 (not shown)
3-bit ACK/NACK: 2 (See Table 15)
4-bit ACK/NACK: 4 (See Table 16)

Referring to FIG. 30, 3-bit A/N performance is lower than 4-bit A/N performance. Since the distance between constellations of the same channel is shorter than the distance between different channels, the entire performance may be dependent upon the distance between constellations contained in a short channel having a short distance. For example, the possibility of ‘NACK to ACK error’ in CH1 of Table 15 is 7/8, and the possibility of ‘NACK to ACK error’ in CH1 of Table 16 is 7/12, so that the error possibility of Table 16 is lower than that of Table 15. Because of the above reasons, channel selection performance of 4-bit ACK/NACK having a larger information size is better than that of 3-bit ACK/NACK.

In order to solve the above-mentioned problems, the following methods are proposed. For convenience of description, although DTX and NACK have the same state (i.e., NACK/DTX), it should be noted that the following embodiment can also be applied to a codebook in which DTX and NACK are distinguished from each other.

First, if the size of ACK/NACK information bits is denoted by an odd number, the number of channels for use in the channel selection scheme is higher than a minimum number of channels by one. For example, as can be seen from Table 15, a minimum number of channels required for transmitting 3-bit ACK/NACK using channel selection based on QPSK constellation is 2. However, the present invention proposes a method for transmitting data or information using three channels.

In this case, a total size of information capable of being transmitted over three channels is 12, so that 4 states may not be used. In this case, the remaining four states may be used for transmitting other ACK/NACK information including DTX. In addition, according to the rule for selecting 8 states from among 12 states, a channel domain having the longest distance is firstly used in a manner that channel domains having long distance between constellations can be sequentially utilized in the same channel in the order of the reducing distance between constellations. In this case, ACK/NACK information based on different channels may be complementary to each other. For example, provided that NNN information is used on CH1, AAA codeword complementary to the NNN information may be transmitted over CH2 and CH3. ACK/NACK codewords each having a long hamming distance are first allocated to different channels, and the order of priorities of the ACK/NACK codewords is determined according to the error rate required for the same channel. For example, a miss ACK rate requirement is set to 1% and N->A error requirement is set to 0.1%, so that “ACK/NACK codeword vs [channel, constellation point] mapping” may be carried out in a condition that priority may be assigned to N->A.

Table 20 exemplarily shows the mapping table for channel selection according to one embodiment of the present invention.

TABLE 20

| | | |
|---|---|---|
| Ch1 | Ch2 | Ch3 |

| | | | | | | |
|---|---|---|---|---|---|---|
| A/N codeword | RS | Data | RS | Data | RS | Data |

| | | | | | | | |
|---|---|---|---|---|---|---|---|
| 0 | N, N, N | 1 | 1 | 0 | 0 | 0 | 0 |
| 1 | N, N, A | 1 | −j | 0 | 0 | 0 | 0 |
| 2 | N, A, N | 1 | j | 0 | 0 | 0 | 0 |
| 3 | N, A, A | 0 | 0 | 0 | 0 | 1 | 1 |
| 4 | A, N, N | 0 | 0 | 1 | 1 | 0 | 0 |
| 5 | A, N, A | 0 | 0 | 1 | −j | 0 | 0 |
| 6 | A, A, N | 0 | 0 | 1 | j | 0 | 0 |
| 7 | A, A, A | 0 | 0 | 0 | 0 | 1 | −1 |

In Table 20, A/N codeword (CW) includes a plurality of HARQ-ACKs. Each HARQ-ACK denotes ACK/NACK/DTX responses for downlink (DL) transmission. DL transmission includes a PDSCH or a PDCCH (e.g., SPS (semi-persistent scheduling) release PDCCH) without a corresponding PDSCH. ACK/NACK/DTX response may include ACK, NACK, DTX or NACK/DTX. NACK/DTX indicates NACK or DTX. A data column denotes a modulation value corresponding to A/N codewords (i.e., a plurality of HARQ-ACKs). Table 20 assumes QPSK modulation. ChX denotes an X-th PUCCH resource (e.g., PUCCH 1b resource: n⁽¹⁾_{PUCCH}) reserved for channel selection. ChX may be implicitly given as shown in Equation 10, or may be explicitly given through DCI on PDCCH. A modulation value (or 2-bit value, i.e., b(0)b(1)) corresponding to the A/N codeword (i.e., a plurality of HARQ-ACKs) is transmitted on uplink through the selected ChX. Meanwhile, RS column denotes a modulation value loaded on the demodulated RS for PUCCH.

Referring to Table 20, each of CW0 (NNN) and CW3 (NAA) has a hamming distance of 2. In case of CW0→CW3 error, “N→A error event” occurs in an order of 2. Therefore, CW0 and CW3 are arranged at different channels (e.g., CH1 and CH3). Likewise, in the case of CW4 (ANN) and CW7 (AAA), the hamming distance is 2 and “N→A error event” has the order of 2, so that CW4 and CW7 are arranged at different channels (e.g., CH2 and CH3). In the case of CW1 and CW2 (or CW5 and CW6), although the hamming distance is 2, “N→A error” has the order of 1 from the viewpoint of one way (CW1→CW2 or CW2→CW1). Thus, CW1 and CW2 (or CW5 and CW6) are arranged on the same channel whereas they are arranged to have the longest distance between their constellation points (for example, respective codewords may be arranged in the form of (j,−j) [or (1,−1)]. CW0→CW1 or CW0→CW2 (or CW4→CW5 or CW4→CW6) may have the hamming distance of 1, and “N→A order” is 1. Thus, two codewords may be arranged at constellation points on a corresponding channel(s) (for example, 1, but may also be arranged at −1, j or −1).

In another method, the present invention can generate the codebook using the ACK/NACK codebook subset method. That is, the largest codebook size capable of being used is defined, and the subset of the codeword may be used for ACK/NACK information having the size smaller than the largest codebook size. For example, provided that 4-bit ACK/NACK for use in the channel selection scheme has a maximum size, 4-bit ACK/NACK codebook is generated, and ACK/NACK codebook of 2 or 3 bits may be configured to use the subset of the 4-bit A/N codebook.

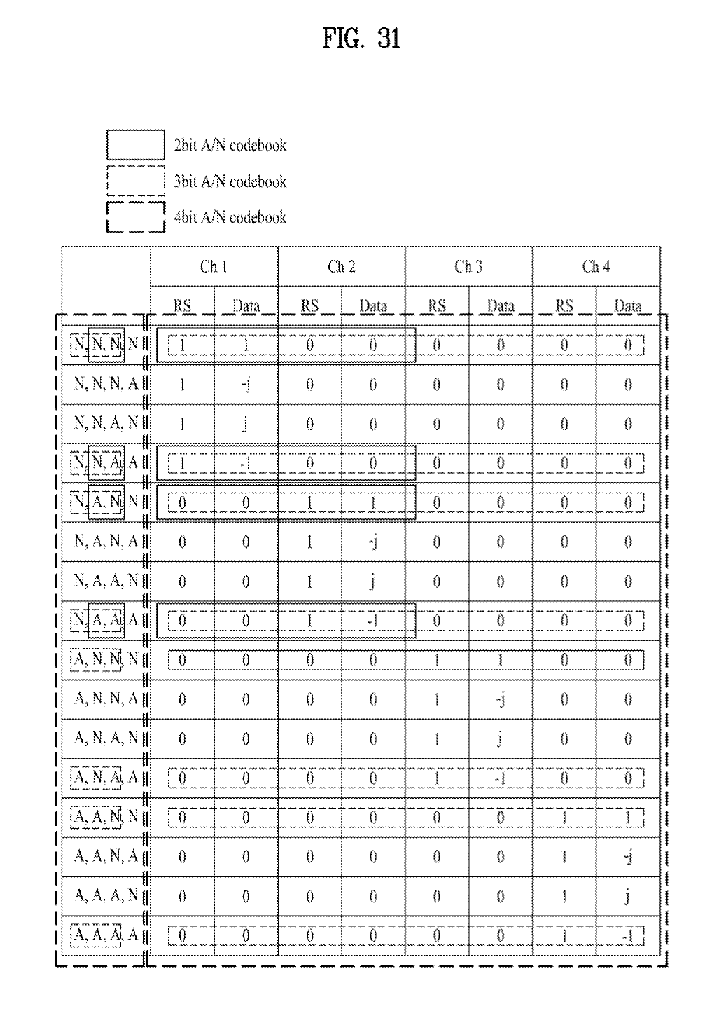

FIG. 31 exemplarily shows the ACK/NACK codebook according to one embodiment of the present invention. In FIG. 31, the ACK/NACK codebook is generated on the assumption that a maximum of ACK/NACK bits is 4, and the associated subset is used as the codebook for 2 or 3 bit ACK/NACK. Here, it is assumed that the number of channels for 3-bit ACK/NACK is set to 4. If the A/N information bit size is an odd number, the number of used channels may be set to an even number higher than a minimum number of necessary channels. In more detail, if the ACK/NACK information bit size is an odd number, the smallest even number of channels from among integers, each of which is higher than a minimum integer (K) satisfying the minimum number (2̂N_info<=M*K) of channels, may be used. That is, although K is set to 2 (K=2) so that two channels are needed, the present invention is configured to use four channels. Referring to the 3-bit ACK/NACK codebook, only in the case of the hamming distance=1, codewords can be mapped to different constellation points on the same channel in such a manner that the distance between constellation points is maximized. However, the scope or spirit of the present invention is not limited to an even number of channels required for ACK/NACK transmission, and it should be noted that the number of channels for 3-bit ACK/NACK may be set to 3 as described above.

If 2 bit, 3 bit, and 4 bit ACK/NACK codebook tables are defined as shown in FIG. 31, Table 21, Table 22, and Table 23 can be respectively obtained.

TABLE 21

| | |
|---|---|
| Ch1 | Ch2 |

| A/N codeword | RS | Data | RS | Data |
|---|---|---|---|---|
| N, N | 1 | 1 | 0 | 0 |
| A, N | 1 | −1 | 0 | 0 |
| N, A | 0 | 0 | 1 | 1 |
| A, A | 0 | 0 | 1 | −1 |

TABLE 22

| A/N | Ch 1 | | Ch 2 | | Ch 3 | | Ch4 | |
|---|---|---|---|---|---|---|---|---|
| codeword | RS | Data | RS | Data | RS | Data | RS | Data |
| N, N, N | 1 | 1 | 0 | 0 | 0 | 0 | 0 | 0 |
| N, N, A | 1 | −1 | 0 | 0 | 0 | 0 | 0 | 0 |
| N, A, N | 0 | 0 | 1 | 1 | 0 | 0 | 0 | 0 |
| N, A, A | 0 | 0 | 1 | −1 | 0 | 0 | 0 | 0 |
| A, N, N | 0 | 0 | 0 | 0 | 1 | 1 | 0 | 0 |
| A, N, A | 0 | 0 | 0 | 0 | 1 | −1 | 0 | 0 |
| A, A, N | 0 | 0 | 0 | 0 | 0 | 0 | 1 | 1 |
| A, A, A | 0 | 0 | 0 | 0 | 0 | 0 | 1 | −1 |

TABLE 23

| A/N | Ch 1 | | Ch 2 | | Ch 3 | | Ch 4 | |
|---|---|---|---|---|---|---|---|---|
| codeword | RS | Data | RS | Data | RS | Data | RS | Data |
| N, N, N, N | 1 | 1 | 0 | 0 | 0 | 0 | 0 | 0 |
| N, N, N, A | 1 | −j | 0 | 0 | 0 | 0 | 0 | 0 |
| N, N, A, N | 1 | j | 0 | 0 | 0 | 0 | 0 | 0 |
| N, N, A, A | 1 | −1 | 0 | 0 | 0 | 0 | 0 | 0 |
| N, A, N, N | 0 | 0 | 1 | 1 | 0 | 0 | 0 | 0 |
| N, A, N, A | 0 | 0 | 1 | −j | 0 | 0 | 0 | 0 |
| N, A, A, N | 0 | 0 | 1 | j | 0 | 0 | 0 | 0 |
| N, A, A, A | 0 | 0 | 1 | −1 | 0 | 0 | 0 | 0 |
| A, N, N, N | 0 | 0 | 0 | 0 | 1 | 1 | 0 | 0 |
| A, N, N, A | 0 | 0 | 0 | 0 | 1 | −j | 0 | 0 |
| A, N, A, N | 0 | 0 | 0 | 0 | 1 | j | 0 | 0 |
| A, N, A, A | 0 | 0 | 0 | 0 | 1 | −1 | 0 | 0 |
| A, A, N, N | 0 | 0 | 0 | 0 | 0 | 0 | 1 | 1 |
| A, A, N, A | 0 | 0 | 0 | 0 | 0 | 0 | 1 | −j |
| A, A, A, N | 0 | 0 | 0 | 0 | 0 | 0 | 1 | j |
| A, A, A, A | 0 | 0 | 0 | 0 | 0 | 0 | 1 | −1 |

In the above-mentioned description, the relationship between the A/N codeword and the CA configuration may be shown in Table 24. It is assumed that two cells (i.e., PCell and SCell) are configured. Each cell may transmit one or two transport blocks according to MIMO configuration.

TABLE 24

A/N codeword

| | HARQ- | HARQ- | HARQ- | HARQ- |
|---|---|---|---|---|
| | ACK(0) | ACK(1) | ACK(2) | ACK(3) |
| 2 bits | PCell TB1 | SCell TB1 | — | — |
| 3 bits | PCell TB1 | PCell TB2 | SCell TB1 | — |
| 3 bits | SCell TB1 | SCell TB2 | PCell TB1 | — |
| 4 bits | PCell TB1 | PCell TB2 | SCell TB1 | SPCell TB2 |

* TB: Transport Block

Although the above-mentioned description is focused upon a plurality of cells (i.e., CC) configured in a carrier aggregation (CA) situation, it should be noted that the present invention can also be easily applied to a TDD system under the condition that one or more cells are configured.

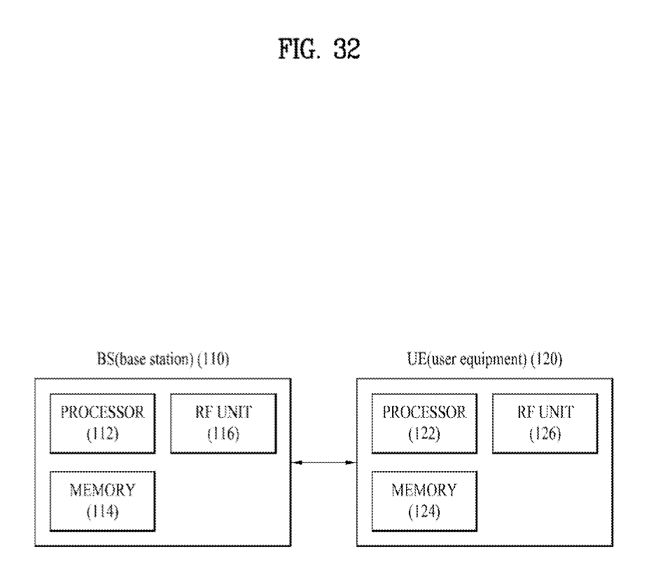

FIG. 32 is a block diagram illustrating a base station (BS) and a user equipment (UE) applicable to embodiments of the present invention.

Referring to FIG. 32, the wireless communication system includes a base station (BS) 110 and a UE 120. The BS 110 includes a processor 112, a memory 114, and a radio frequency (RF) unit 116. The processor 112 may be constructed to implement the procedures and/or methods disclosed in the embodiments of the present invention. The memory 114 may be connected to a processor 112, and store various information related to operations of the processor 112. The RF unit 116 is connected to the processor 112, and transmits and/or receives RF signals. The UE 120 includes a processor 122, a memory 124, and an RF unit 126. The processor 122 may be constructed to implement the procedures and/or methods disclosed in the embodiments of the present invention. The memory 124 may be connected to a processor 122, and store various information related to operations of the processor 122. The RF unit 126 is connected to the processor 122, and transmits and/or receives RF signals. The BS 110 and/or the UE 120 may include a single antenna or multiple antennas.

The aforementioned embodiments are achieved by combination of structural elements and features of the present invention in a predetermined fashion. Each of the structural elements or features should be considered selectively unless specified otherwise. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with other claims referring to claims other than the specific claims to constitute the embodiment or add new claims by means of amendment after the application is filed.

The embodiments of the present invention have been described based on data transmission and reception between a BS (or eNB) and a UE. A specific operation which has been described as being performed by the eNB (or BS) may be performed by an upper node of the eNB (or BS). In other words, it will be apparent that various operations performed for communication with the UE in the network which includes a plurality of network nodes along with the eNB (or BS) can be performed by the BS or network nodes other than the eNB (or BS). The term eNB (or BS) may be replaced with terms such as fixed station, Node B, eNode B (eNB), and access point. Also, the term UE may be replaced with terms such as mobile station (MS) and mobile subscriber station (MSS).

The embodiments according to the present invention can be implemented by various means, for example, hardware, firmware, software, or combinations thereof. If the embodiment according to the present invention is implemented by hardware, the embodiment of the present invention can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the embodiment of the present invention may be implemented by a module, a procedure, or a function, which performs functions or operations as described above. Software code may be stored in a memory unit and then may be driven by a processor. The memory unit may be located inside or outside the processor to transmit and receive data to and from the processor through various well known means.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all changes which come within the equivalent scope of the invention are within the scope of the invention.

### INDUSTRIAL APPLICABILITY

Exemplary embodiments of the present invention can be applied to a user equipment (UE), a base station (BS), and other devices. In more detail, the present invention can be applied to a method and apparatus for transmitting uplink control information.

1. A method for transmitting uplink control information (UCI) on the condition that a plurality of cells is configured in a wireless communication system, the method comprising:
selecting one PUCCH (physical uplink control channel) resource corresponding to N specific HARQ ACKs (hybrid automatic repeat request—acknowledgements) from among a plurality of PUCCH resources in a mapping table for N HARQ-ARQs; and
transmitting a bit value corresponding to the N HARQ-ACKs in the mapping table for the N HARQ-ARQs using the selected PUCCH resource,
wherein the mapping table for the N HARQ-ARQs is contained in a mapping table for M HARQ-ACKs, where N≦M.

2. The method according to claim 1, wherein N is an integer less than M.

3. The method according to claim 1, wherein M is set to 4.

4. The method according to claim 1, wherein the plurality of cells includes a primary cell (PCell) and a secondary cell (SCell).

5. The method according to claim 1, wherein the PUCCH resource includes PUCCH format 1b resource.

6. A communication device for transmitting uplink control information (UCI) on the condition that a plurality of cells is configured in a wireless communication system, the communication device comprising:
a radio frequency (RF) unit; and
a processor,
wherein the processor selects one PUCCH (physical uplink control channel) resource corresponding to N specific HARQ ACKs (hybrid automatic repeat request—acknowledgements) from among a plurality of PUCCH resources in a mapping table for N HARQ-ARQs, and transmits a bit value corresponding to the N HARQ-ACKs in the mapping table for the N HARQ-ARQs using the selected PUCCH resource, wherein the mapping table for the N HARQ-ARQs is contained in a mapping table for M HARQ-ACKs, where N≦M.

7. The communication device according to claim 6, wherein N is an integer less than M.

8. The communication device according to claim 6, wherein M is set to 4.

9. The communication device according to claim 6, wherein the plurality of cells includes a primary cell (PCell) and a secondary cell (SCell).

10. The communication device according to claim 6, wherein the PUCCH resource includes PUCCH format 1b resource.
